(19) United States
(12) Patent Application Publication
(10) Pub. No.: US 2026/0322167 A1
(43) Pub. Date: Oct. 15, 2026

(54) Modular Inductive Charger and System for Rugged Environments

(71) Applicant: AQUA-AMP, LLC, Clearwater, FL (US)

(72) Inventors: Ryan Gregory Pickren, Atlanta, GA (US); Robert James Wellden, Clearwater, FL (US)

(21) Appl. No.: 19/465,391

(22) Filed: Jan. 30, 2026

Related U.S. Application Data
(60) Provisional application No. 63/752,454, filed on Jan. 31, 2025.

(51) Int. Cl. H02J 50/10; H02J 7/70; H02J 50/00; H02J 50/90

(52) U.S. Cl. CPC H02J 50/10; H02J 7/70; H02J 50/005; H02J 50/90

(57) ABSTRACT

An example of an apparatus for inductively charging a device with a planar surface includes a wire coil, a magnetic member with a planar face, and a housing surrounding the wire coil and coupling the wire coil to the magnetic member. The face of the magnetic member can be in substantially direct contact with the surface of the device at a planar boundary.

### CROSS-REFERENCE TO RELATED APPLICATION

This claims the benefit of priority from U.S. provisional Application No. 63/752,454, filed Jan. 31, 2025, which is hereby incorporated by reference in its entirety.

### FIELD

This disclosure relates to inductive chargers, specifically, modular inductive chargers and inductive chargers for rugged environments.

### BACKGROUND

Inductive chargers for electronic devices have become increasingly popular. Inductive chargers transfer energy through electromagnetic induction between a coil in the charger and a coil in a charged device. They may also include non-electronic features that add functionality, such as a body that allows the charger to stand on a desk and hold a charged device upright. (See, for example, the MagSafe iPhone Desk Shelf Mount by Oakywood.)

It is often desirable, and sometimes required, to have such chargers independently certified for their electronic features. For example, many such chargers are QI® certified (QI is a registered certification mark of Wireless Power Consortium, Inc.). Even minor modifications to the structure of such chargers can necessitate obtaining an entirely new certification. This is often the case even where modifications only affect non-electronic features. It is desirable to implement an inductive charger as part of a modular inductive charger system with integrated electronic and non-electronic features. In such a system, non-electronic features can be altered without requiring a new certification, and/or electronic features covered by a single certification can be designed to work with multiple non-electronic features.

U.S. Pat. No. 2025/0373037 to Drumb et al. (“Drumb”) discloses an inductive charging tray assembly for a vehicle with a base plate configured to be mounted onto a structure on the vehicle. The tray is configured to receive an inductive charging device installed by a user, and the inductive charging device may be removed from the tray by the user. However, the inductive charging tray assembly of Drumb is not designed for vehicles undergoing heavy turbulence, as is commonly experienced on watercraft like boats. What is needed is a modular inductive charger and system that facilitate secure, releasable coupling between electronic and non-electronic features and between the charger and a charged device. Additionally, Drumb does not discuss features for increasing water or liquid resistance or otherwise rendering the inductive charging tray assembly or device resistant to outdoor elements. What is needed is a modular inductive charger and system that include features for increasing resistance to liquids like water and other potentially damaging phenomena like outdoor elements.

Inductive chargers commonly include a magnetic member in the form of a magnetic ring. This ring is intended to align a coil in the charger with a coil in the charged device, in order to maximize efficiency of the inductive power transfer. However, the magnetic force of the ring is generally too weak to securely hold a charged device, e.g., an iPhone®. Part of the reason for this is magnetic rings are generally enveloped in a housing, not exposed for direct contact with the charged device. What is needed is an inductive charger with a magnetic ring that can be in substantially direct contact with a charged device to securely hold the charged device.

### BRIEF SUMMARY

An example of a system that meets these needs includes a modular charger having a waterproof housing, a coil within the housing, a magnetic member proximal the coil, and a PCB. The system also has a receiver and a module connector for releasably coupling the receiver to the modular charger.

The modular charger system may also include one or more of the following advantages.

The housing may generally be shaped like a conical frustum. The housing may have a rear face. The system may further include a central collar protruding from a center of the rear face and an offset collar protruding from the rear face.

The module connector may be a nut that fastens or screws onto the housing and/or the central collar.

The PCB may be within the housing.

The PCB and/or coil may be potted.

The receiver may be part of a watercraft.

An example of an apparatus that meets the needs identified above is an apparatus for inductively charging a device with a planar surface. The apparatus includes a wire coil, a magnetic member with a planar face, and a housing surrounding the wire coil and coupling the wire coil to the magnetic member. The face of the magnetic member can be in substantially direct contact with the surface of the device at a planar boundary.

The apparatus may also include one or more of the following advantages.

The apparatus may include epoxy that encloses the magnetic member and/or is over the face of the magnetic member. The epoxy may have a thickness of 1-16 microns over the face of the magnetic member.

The housing may define a recess, and the magnetic member may be within the recess.

The recess may include anchor protrusions.

A magnetic force of the magnetic member may be able to force a charged device against the housing. The apparatus may not include any means other than the magnetic member for forcing the device against the housing.

The magnetic member may engage a charged device via magnetic force of the magnetic member to position the device relative to the wire coil.

The magnetic member may be annular. A magnetic flux density due to the magnetic member may have a value not exceeding 0.215 T at the face of the magnetic member. An inner diameter of the magnetic member may be 46 millimeters.

A second example of an inductive charger system includes a core having a front face and a rear face, a flange extending from the front face and defining channels, a central collar protruding from the rear face and defining a central lumen, and an offset collar protruding from the rear face and defining an offset lumen. The system further includes a coil section having an insulative polymer frame and a coil of copper wire. The system further includes a potted PCB for modulating current through the wire, an aluminum alloy plate defining plate holes therethrough, and a polymer insulator. The system further includes a cover having a front surface defining a planar portion and a peripheral groove with anchor protrusions, a rear surface, and a tapered flange extending away from the rear surface and defining locking protrusions. The system further includes a magnetic ring within the peripheral groove and epoxy within the peripheral groove and fully encasing the magnetic ring to secure the magnetic ring within the peripheral groove. The epoxy is distributed such that the epoxy and the planar portion form a substantially unitary and planar surface. The locking protrusions of the cover are within the channels of the core to secure the cover to the core. The coil section, PCB, plate, and insulator are between and enclosed by the cover and the core.

### BRIEF DESCRIPTION OF THE DRAWINGS

FIG. 1 is a diagram of an example of a modular inductive charger system.

FIG. 2 is a front perspective view of an example of a modular inductive charger.

FIG. 3 is a front view of the example of a modular inductive charger.

FIG. 4 is a rear view of the example of a modular inductive charger.

FIG. 5 is a right side view of the example of a modular inductive charger.

FIG. 6 is a left side view of the example of a modular inductive charger.

FIG. 7 is a top view of the example of a modular inductive charger.

FIG. 8 is a bottom view of the example of a modular inductive charger.

FIG. 9 is a rear perspective view of the example of a modular inductive charger.

FIG. 10 is a right side cross-section view of the example of a modular inductive charger.

FIG. 11 is a right side cross-section view of the example of a modular inductive charger, wherein features within the housing are completely potted.

FIG. 12 is a front perspective exploded view of the example of a modular inductive charger.

FIG. 13 is a rear perspective exploded view of the example of a modular inductive charger.

FIG. 14 is a front perspective view of an example of a core.

FIG. 15 is a rear perspective view of the example of a core.

FIG. 16 is a rear view of the example of a core.

FIG. 17 is a front view of the example of a core.

FIG. 18 is a bottom view of the example of a core.

FIG. 19 is a top view of the example of a core.

FIG. 20 is a left side view of the example of a core.

FIG. 21 is a right side view of the example of a core.

FIG. 22 is a front perspective view of an example of a PCB.

FIG. 23 is a front view of the example of a PCB, the rear view being identical.

FIG. 24 is a top view of the example of a PCB.

FIG. 25 is a bottom view of the example of a PCB.

FIG. 26 is a front perspective view of an example of a plate.

FIG. 27 is a front view of the example of a plate, the rear view being identical.

FIG. 28 is a front perspective view of an example of an insulator.

FIG. 29 is a front view of the example of an insulator, the rear view being identical.

FIG. 30 is a right side view of the example of an insulator, the left side view being identical.

FIG. 31 is a front perspective view of an example of a coil section.

FIG. 32 is a rear perspective view of the example of a coil section.

FIG. 33 is a front view of the example of a coil section.

FIG. 34 is a rear view of the example of a coil section.

FIG. 35 is a left side view of the example of a coil section.

FIG. 36 is a right side view of the example of a coil section.

FIG. 37 is a top view of the example of a coil section.

FIG. 38 is a bottom view of the example of a coil section.

FIG. 39 is a rear perspective view of the example of a coil section, wherein the example of a coil section is fully potted.

FIG. 40 is a front perspective view of an example of a cover.

FIG. 41 is a rear perspective view of the example of a cover.

FIG. 42 is a front view of the example of a cover.

FIG. 43 is a rear view of the example of a cover.

FIG. 44 is a top view of the example of a cover.

FIG. 45 is bottom view of the example of a cover.

FIG. 46 is a front perspective view of an example of a magnetic member.

FIG. 47 is a rear perspective view of the example of a magnetic member.

FIG. 48 is a right side view of the example of a magnetic member.

FIG. 49 is a front perspective view of the example of a modular inductive charger, wherein the magnetic member is enclosed by epoxy within the cover peripheral groove of the housing.

FIG. 50 is a top cross-section view of the example of a modular inductive charger as depicted in FIG. 49, wherein the cover peripheral groove is shown zoomed in.

FIG. 51 is a rear perspective view of the example of a modular inductive charger of FIG. 49 adjacent a device, wherein an arrow shows how the modular inductive charger can be removably coupled to the device.

FIG. 52 is a bottom cross-section view of the example of a modular inductive charger of FIG. 49 contacting a device.

FIG. 53 is a front perspective view of an example of a receiver.

FIG. 54 is a rear perspective view of the example of a receiver.

FIG. 55 is a perspective view of the example of a receiver installed in a watercraft hull.

FIG. 56 is a second perspective view of the example of a receiver installed in a watercraft hull.

FIG. 57 is a front view of the example of a receiver.

FIG. 58 is a rear view of the example of a receiver.

FIG. 59 is a top view of the example of a receiver.

FIG. 60 is a bottom view of the example of a receiver.

FIG. 61 is a right side view of the example of a receiver.

FIG. 62 is a left side view of the example of a receiver.

FIG. 63 is a front perspective exploded view of the example of a receiver.

FIG. 64 is a rear perspective exploded view of the example of a receiver.

FIG. 65 is a front perspective view of the example of a modular inductive charter installed in the example of a receiver.

FIG. 66 is a rear perspective view of the example of a modular inductive charter installed in the example of a receiver.

FIG. 67 is a front perspective exploded view of the example of a receiver uninstalled from the example of a modular inductive charger.

FIG. 68 is a rear perspective exploded view of the example of a receiver uninstalled from the example of a modular inductive charger.

FIG. 69 is a front perspective exploded view of the example of a receiver uninstalled from the example of a modular inductive charger, wherein the modular inductive charger is rotated ninety degrees as compared to FIGS. 65-68.

FIG. 70 is a rear perspective exploded view of the example of a receiver uninstalled from the example of a modular inductive charger, wherein the modular inductive charger is rotated ninety degrees as compared to FIGS. 65-68.

FIG. 71 is a front perspective view of the example of a modular inductive charger installed in the example of a receiver, wherein the modular inductive charger is rotated ninety degrees as compared to FIGS. 65-68.

FIG. 72 is a rear perspective view of the example of a modular inductive charger installed in the example of a receiver, wherein the modular inductive charger is rotated ninety degrees as compared to FIGS. 65-68.

FIG. 73 is a front bottom perspective view of a second example of a receiver.

FIG. 74 is a rear top perspective view of the second example of a receiver.

FIG. 75 is a front view of the second example of a receiver.

FIG. 76 is a rear view of the second example of a receiver.

FIG. 77 is a right side view of the second example of a receiver.

FIG. 78 is a left side view of the second example of a receiver.

FIG. 79 is a top view of the second example of a receiver.

FIG. 80 is a bottom view of the second example of a receiver.

FIG. 81 is a front top perspective view of the second example of a receiver.

FIG. 82 is a front bottom perspective view of the second example of a receiver.

FIG. 83 is a front top perspective view of the example of a modular inductive charger installed in the second example of a receiver.

FIG. 84 is a front perspective view of the example of a modular inductive charger installed in the second example of a receiver.

FIG. 85 is a right side cross-section view of the example of a modular inductive charger installed in the second example of a receiver.

FIG. 86 is a top perspective view of a third example of a receiver.

FIG. 87 is a bottom perspective view of the third example of a receiver.

FIG. 88 is a front view of the third example of a receiver.

FIG. 89 is a rear view of the third example of a receiver.

FIG. 90 is a right side view of the third example of a receiver.

FIG. 91 is a left side view of the third example of a receiver.

FIG. 92 is a top view of the third example of a receiver.

FIG. 93 is a bottom view of the third example of a receiver.

### DETAILED DESCRIPTION

This disclosure describes examples and features, but not all possible examples and features of the modular inductive charger and system. Where a particular feature is disclosed in the context of a particular example, that feature can also be used, to the extent possible, in combination with and/or in the context of other examples. The modular inductive charger and system may be embodied in many different forms and should not be construed as limited to only the examples and features described here.

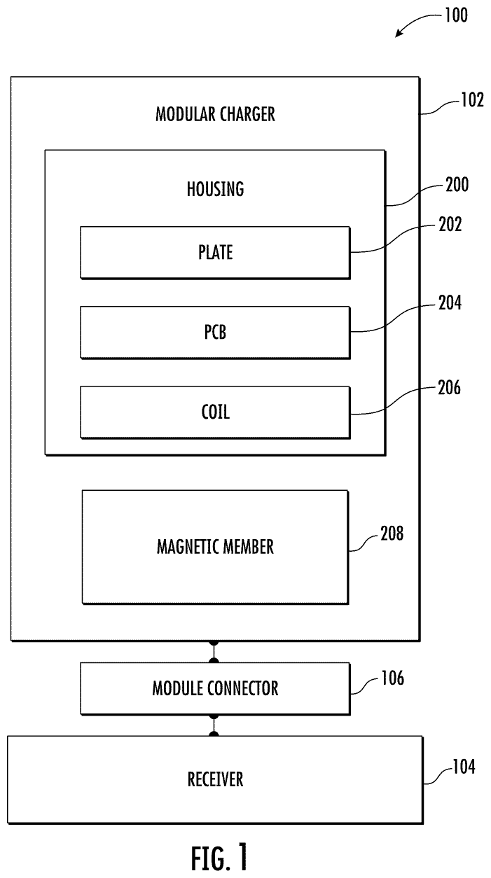

Referring to FIG. 1, an example of a system intended to overcome disadvantages of the prior art is an inductive charger system 100 with a modular charger 102, a receiver 104, and a module connector 106. The modular charger 102 includes a housing 200, a plate 202, a PCB 204, a coil 206, and a magnetic member 208. In the example shown, the PCB 204 is within the housing 200, but in other examples, the PCB 204 may not be within the housing 200 and may be within a separate housing (not shown). The plate 202 and coil 206 are within the housing 200. The magnetic member 208 is proximal to the coil 206. The module connector 106 releasably couples the receiver 104 to the modular charger 102.

The housing 200 is waterproof. As used herein, “waterproof” in reference to an object means the object is substantially impervious to water. In the example shown, the housing 200 seals the plate 202, PCB 204, and coil 206 from external water sufficiently that the modular charger 102 can reasonably be used in and around water and/or submerged without water interfering with operation of the modular charger 102.

The receiver 104 may have many different forms and/or features. For example, the receiver 104 may be part of a watercraft, such as a boat dashboard or deck. The receiver 104 may also be a form box. The modular charger 102 can be transferred between receivers 104 as desired without requiring additional certification of the modular charger 102. Additionally, the modular charger 102 can be manufactured in larger quantities since the same modular charger 102 can be used for many applications through the use of different receivers 104.

The inductive charger system 100 may be installed in or on a building, in or on a vehicle, such as a car or boat, or otherwise be integrated with a distinct structure. Due to the modular nature of the inductive charger system 100, technology in electronic features of the inductive charger system 100 can be upgraded without requiring any changes to the structure with which the inductive charger system 100 is integrated. For example, a boat manufacturer might design a boat dashboard around the inductive charger system 100, in which case electronic features, such as the modular charger 102, of the inductive charger system 100 could be upgraded (e.g., from 15 W output to 25 W output) without any redesign, retooling, or additional testing by the boat manufacturer. Boat manufacturers can design their dashboards and vehicle geometry around the inductive charger system 100 once, knowing electronic features can be exchanged or upgraded at any time without them having to modify anything.

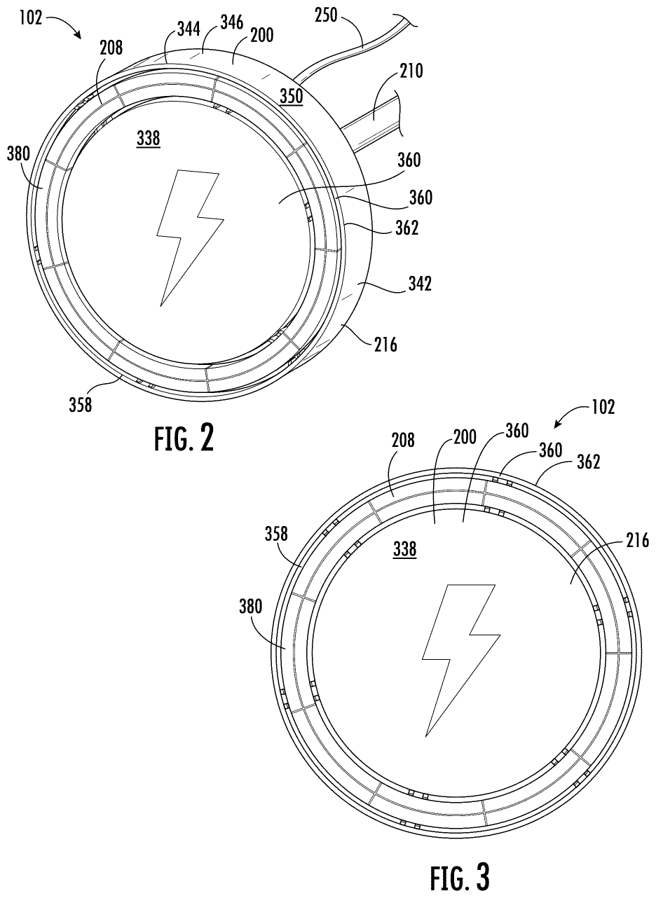

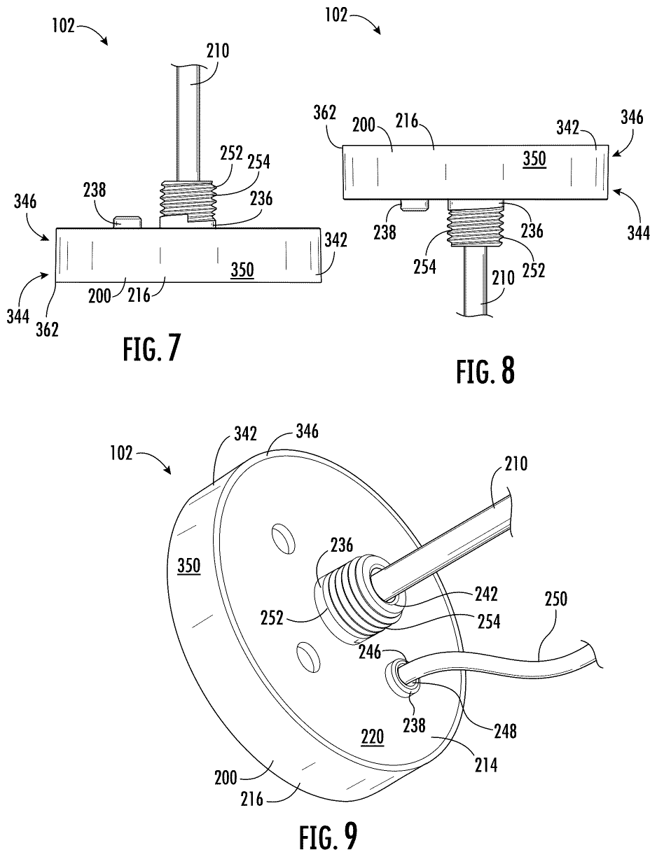

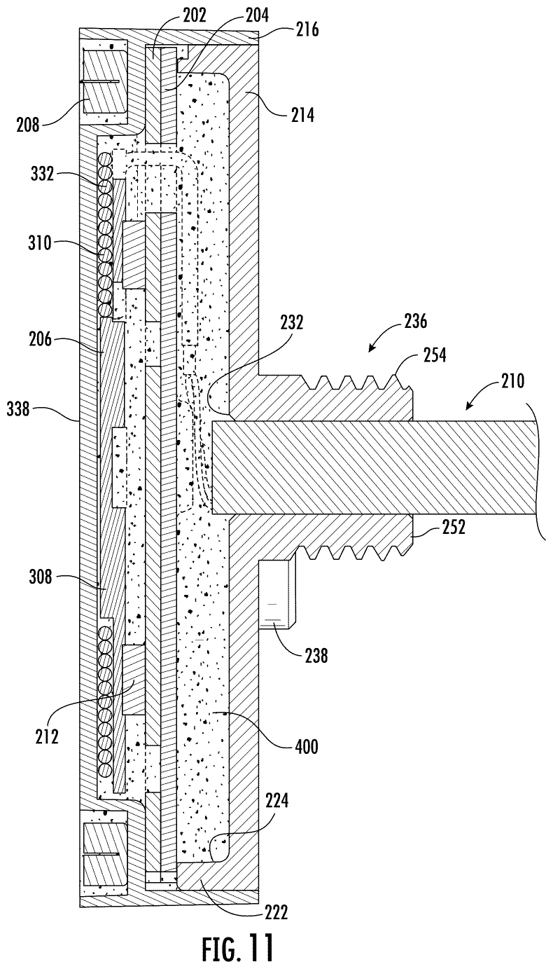

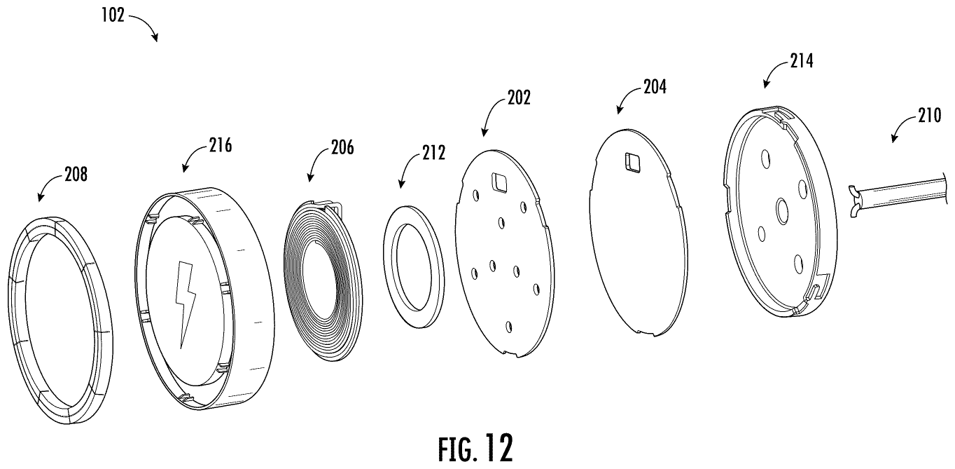

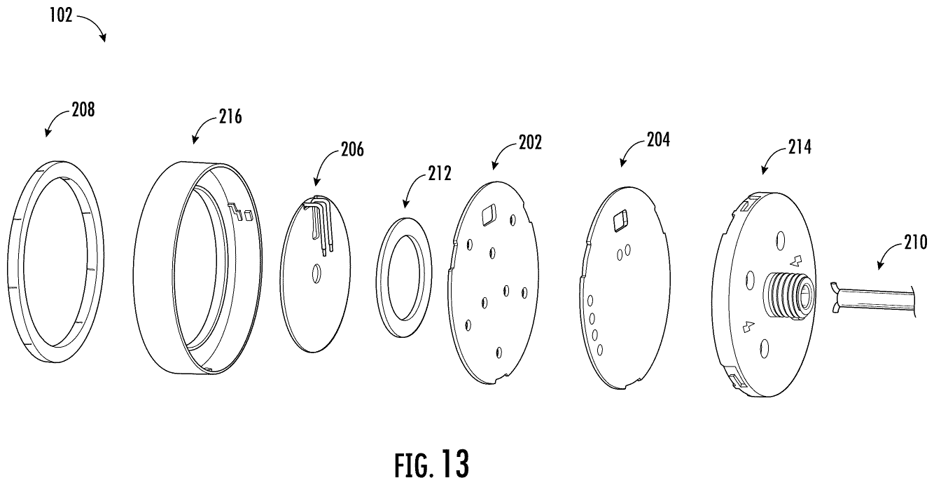

Referring now to FIGS. 2-13, an example of a modular charger 102 includes a power cord 210, a PCB 204, a plate 202, an insulator 212, a coil section 206, a magnetic member 208, and a housing 200 including a core 214 and a cover 216, which are now described in more detail.

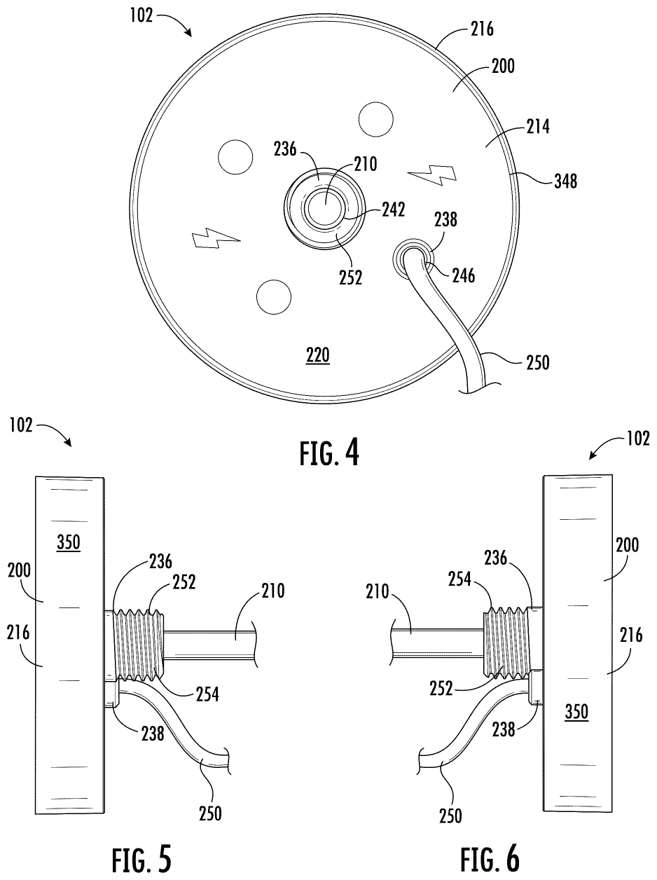

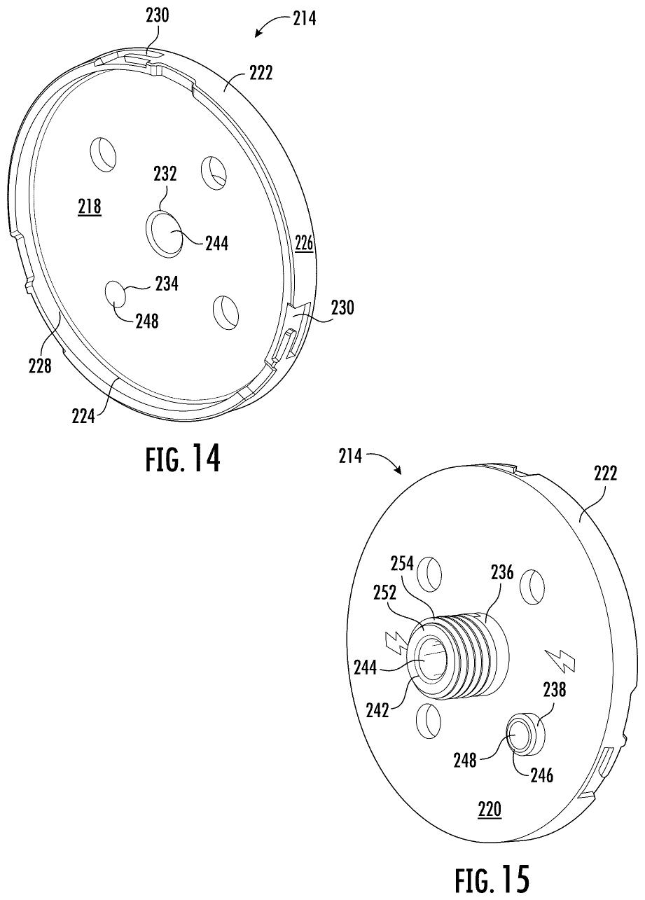

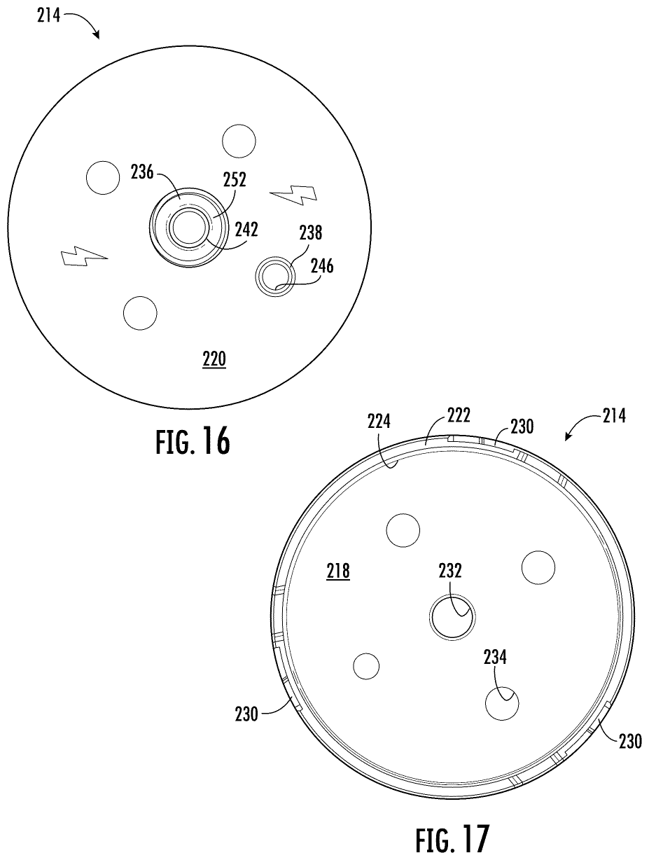

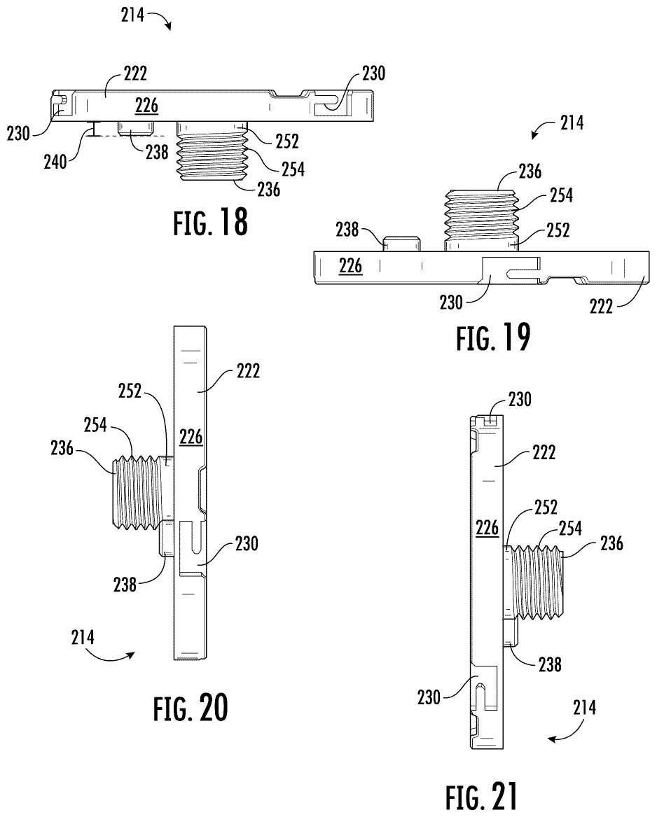

Referring to FIGS. 4-11 and 14-21, an example of a core 214 includes a core front face 218, a core rear face 220, and a core flange 222. The core flange 222 extends from a periphery 224 of the core front face 218 and away from the core rear face 220. The core flange 222 has a core flange exterior surface 226 and a core flange interior surface 228. The core flange exterior surface 226 defines channels 230. The core front face 218 defines a core central aperture 232 and a core offset aperture 234. The core rear face 220 defines a central collar 236 and an offset collar 238. The central collar 236 and offset collar 238 respectively extend away from the core front face 218. The offset collar 238 extends a height 240 from the core rear face 220 away from the core front face 218. The central collar 236 defines a central collar aperture 242 and a central lumen 244 extending from the central collar aperture 242 to the core central aperture 232. The offset collar 238 defines an offset collar aperture 246 and an offset lumen 248 extending from the offset collar aperture 246 to the core offset aperture 234. As shown in FIG. 9, the offset lumen 248 receives a digital output cable 250 for the modular charger 102. The central collar 236 has a central collar exterior surface 252. The central collar exterior surface 252 defines collar threads 254. In the example shown, the core 214 is made from injection molded polymer, but in other examples, it may be made from one or more other materials, such as pure metals, metal alloys, composites, soft polymers, or the like.

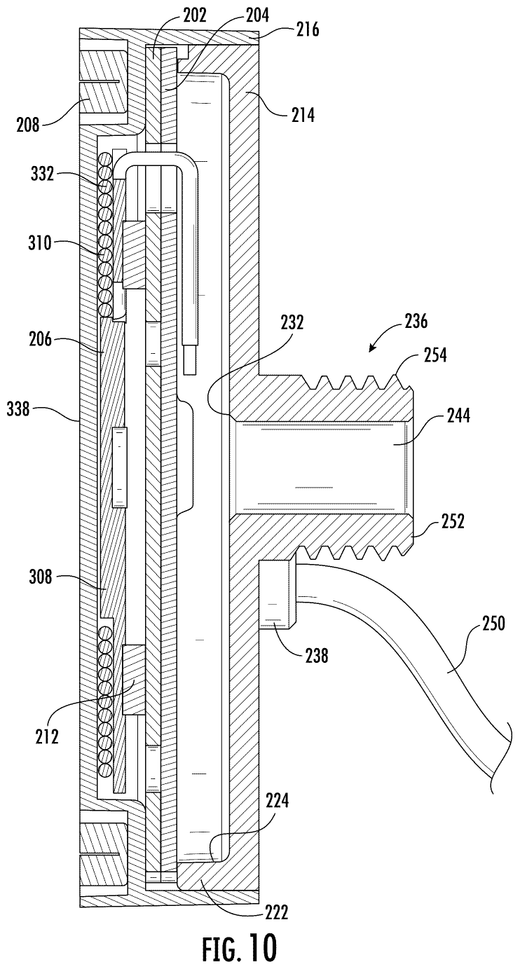

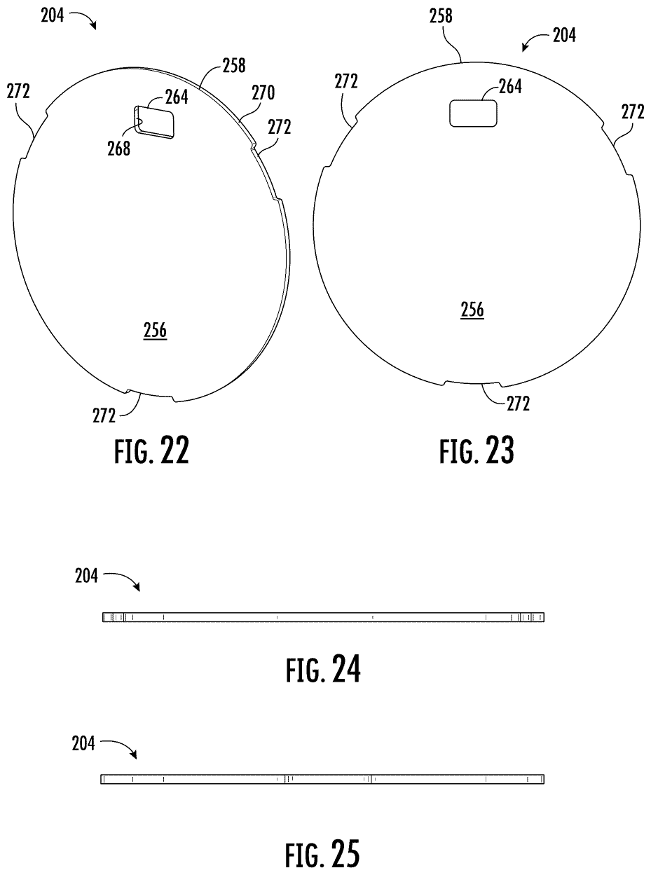

Referring to FIGS. 10-11 and 22-25, an example of a PCB 204 has a PCB face 256 with a PCB face periphery 258. The PCB face 256 defines a PCB port 264. A PCB lumen 268 extends through the PCB 204. A PCB peripheral surface 270 is adjacent the PCB face periphery 258. The PCB peripheral surface 270 defines PCB notches 272. The PCB notches 272 can help inhibit movement of the PCB 204 within the housing 200. The PCB 204 may be “potted,” i.e., coated in an insulative, waterproof material.

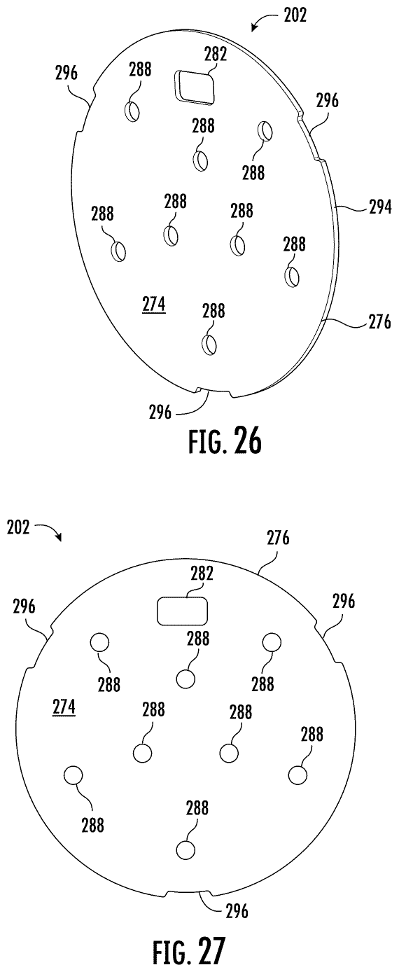

Referring to FIGS. 26-27, an example of a plate 202 has a plate face 274 with a plate face periphery 276. The plate face 274 defines a plate port 282. The plate face 274 defines plate holes 288. The plate holes 288 facilitate flow of liquids, such as epoxy 400, through the plate 202 when features of the modular inductive charger 102 are potted. A plate peripheral surface 294 is adjacent the plate face periphery 276. The plate peripheral surface 294 defines plate notches 296. The plate notches 296 can help inhibit movement of the plate 202 within the housing 200. In the example shown, the plate 202 is made of an aluminum alloy, but it may be made from one or more other materials, such as one or more of a pure metal, a metal alloy, a polymer, a composite, glass, wood, and the like.

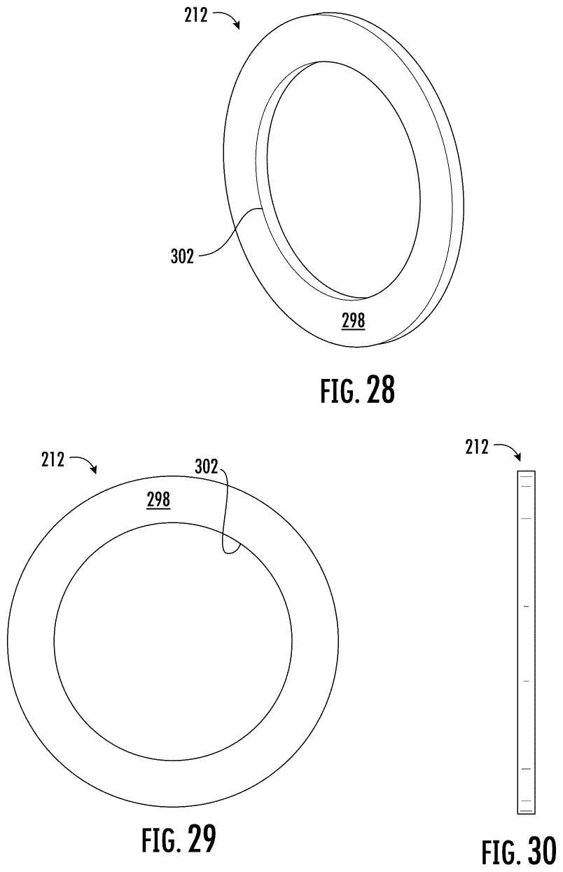

Referring to FIGS. 28-30, an example of an insulator 212 includes an insulator face 298. The insulator face 298 defines an insulator aperture 302. In the example shown, the insulator 212 is made from ethylene-vinyl acetate. However, in other examples, the insulator 212 may be made from one or more other polymers or insulative materials.

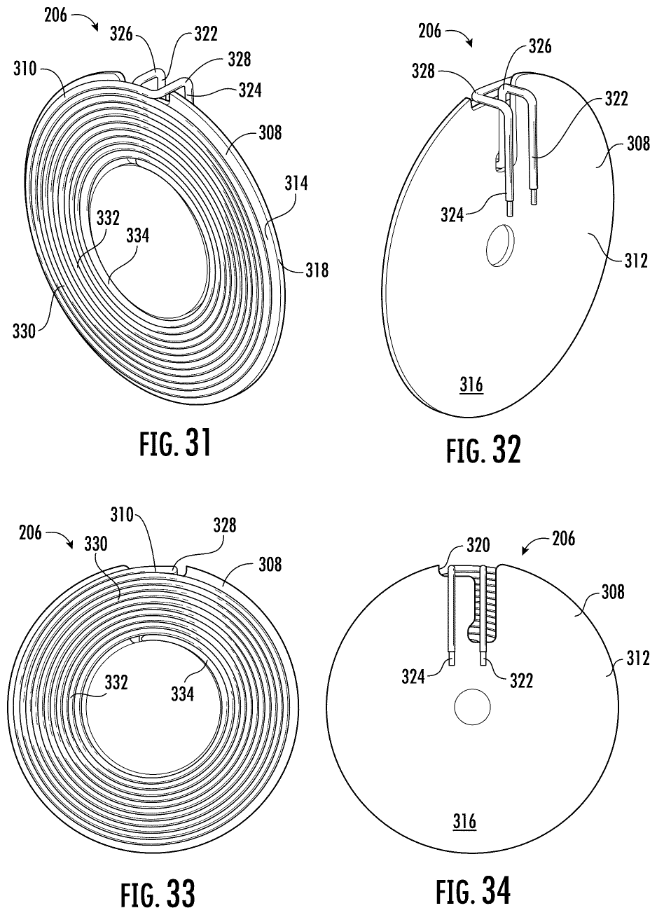

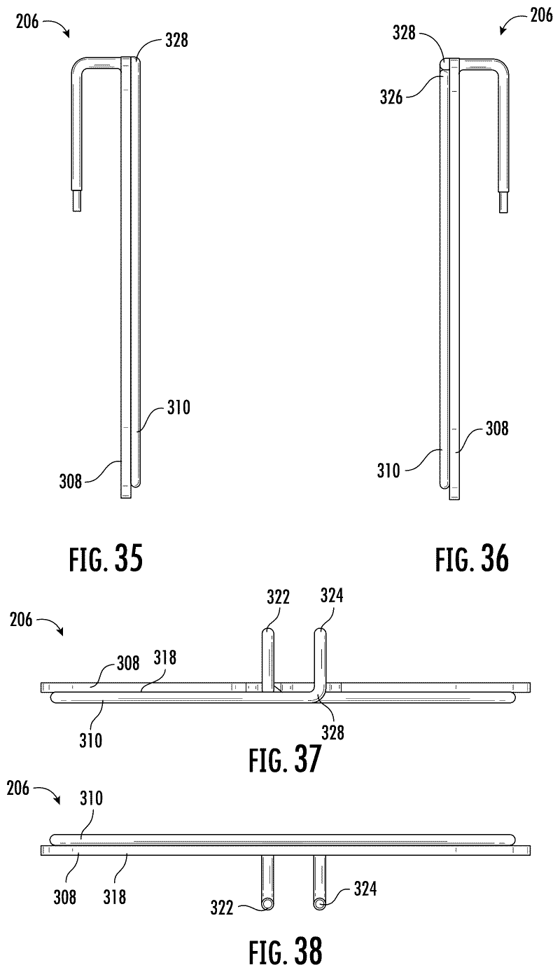

Referring to FIGS. 31-39, an example of a coil section 206 includes a coil frame 308 and a wire 310. The coil frame 308 includes a disc body 312 with a front disc face 314 and a rear disc face 316. A disc edge 318 extends from the front disc face 314 to the rear disc face 316. The disc edge 318 defines a wire notch 320. In the example shown, the coil frame 308 is made from an insulative polymer, but in other examples, the coil frame 308 may be made from one or more other insulative materials. The wire 310 has a first wire end 322 and a second wire end 324. The wire 310 includes a first wire bend 326 adjacent the first wire end 322 and a second wire bend 328 adjacent the second wire end 324. A wire body 330 extends from the first wire bend 326 to the second wire bend 328. The wire body 330 is rolled into concentric loops 332. An interior loop 332 defines a coil aperture 334. The loops 332 are adjacent the front disc face 314. The first wire bend 326 and second wire bend 328 are adjacent the wire notch 320. The first wire end 322 and second wire end 324 extend through the wire notch 320 and past the rear disc face 316. In the example shown, the wire 310 is made from a copper alloy, but in other examples, the wire 310 may be made from one or more other conductive materials.

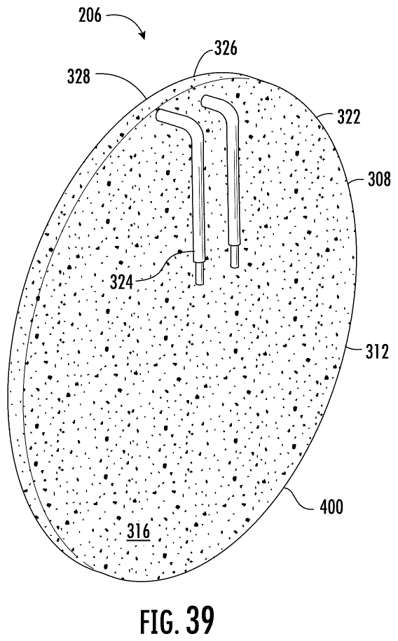

Referring to FIG. 39, the coil section 206 may be partially or completely potted.

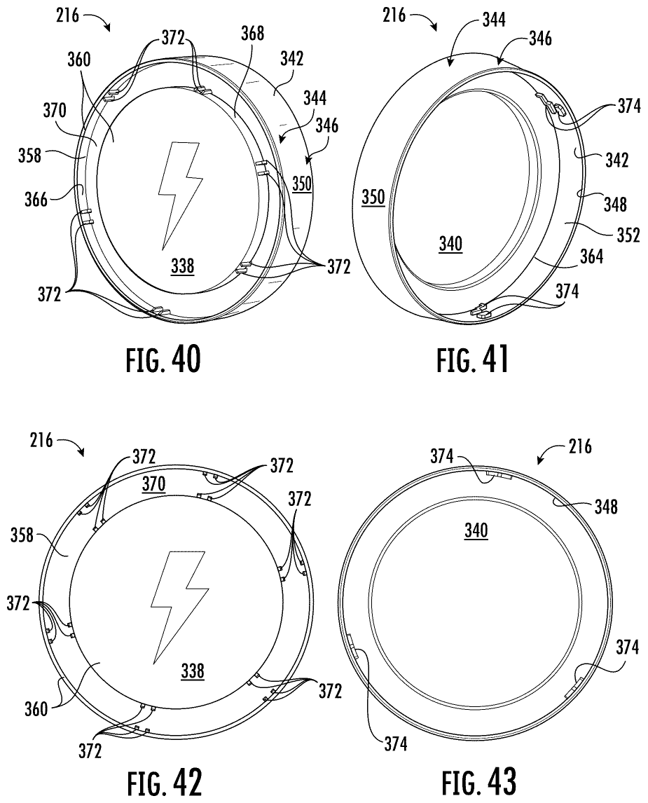

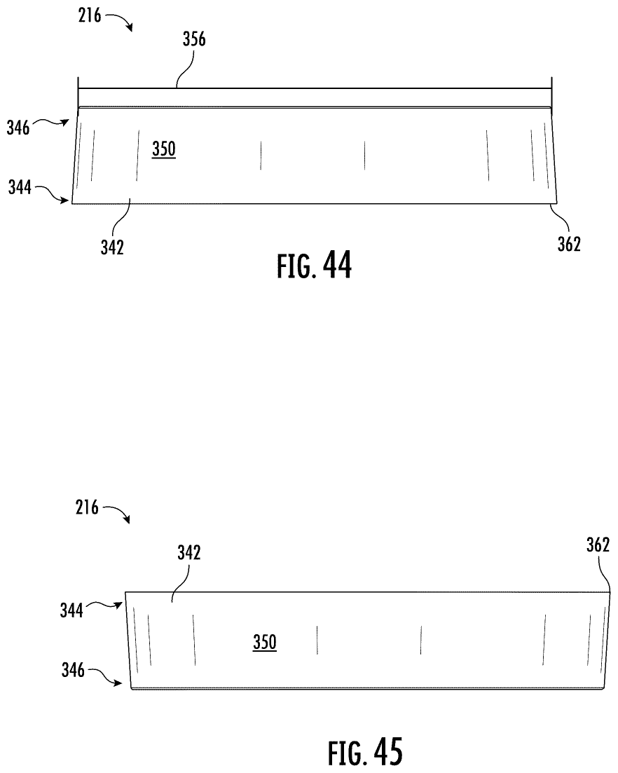

Referring to FIGS. 40-45, an example of a cover 216 includes a cover front face 338, a cover rear face 340, and a cover flange 342. The cover flange 342 includes a cover flange first end 344 proximal the cover front face 338 and a cover flange second end 346 defining a cover flange aperture 348. The cover flange 342 includes a cover flange exterior surface 350 extending from the cover flange first end 344 to the cover flange second end 346 and a cover flange interior surface 352 extending from the cover flange first end 344 to the cover flange second end 346. The cover flange 342 has a cover flange diameter 356. The cover flange diameter 356 decreases linearly from the cover flange first end 344 to the cover flange second end 346, so that the cover flange 342 is tapered.

The cover front face 338 defines a cover peripheral groove 358, a planar portion 360, and a cover exterior shoulder 362. The cover rear face 340 defines a cover interior shoulder 364. The cover peripheral groove 358 is a recess in the cover front face 338. The cover peripheral groove 358 includes a groove outer surface 366, a groove inner surface 368, and a groove back surface 370. The groove outer surface 366 and groove inner surface 368 respectively define anchor protrusions 372. The anchor protrusions 372 extend into the cover peripheral groove 358.

The cover flange interior surface 352 defines locking protrusions 374.

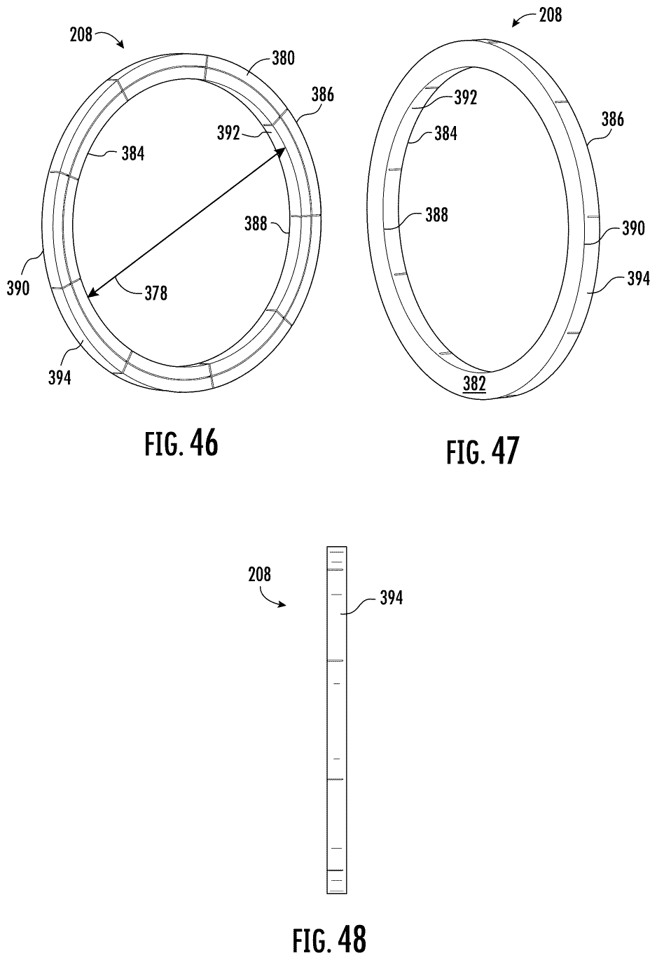

Referring to FIGS. 46-48, an example of a magnetic member 208 is a magnetic ring 208. The magnetic ring 208 is annular and has an inner diameter 378 of 46 mm. In other examples, the magnetic member 208 may have another shape, such as an oval, square, triangle, rectangle, or another desired shape, and/or it may have a different inner diameter 378. The magnetic ring 208 includes a ring front face 380 and a ring rear face 382. The ring front face 380 includes a ring front face inner edge 384 and a ring front face outer edge 386. The ring rear face 382 includes a ring rear face inner edge 388 and a ring rear face outer edge 390. A ring interior surface 392 extends from the ring front face inner edge 384 to the ring rear face inner edge 388. A ring exterior surface 394 extends from the ring rear face outer edge 390 to the ring front face outer edge 386. In the example shown, the magnetic ring 208 is one piece, but in other examples, the magnetic ring 208 may be made up of numerous magnets. The ring front face 380 is planar. As used herein, “planar” in reference to a surface means that the surface, which may not be continuous or unitary, lies in a single plane to a reasonable approximation.

Referring back to FIGS. 2-13, the power cord 210 extends through the central lumen 244. The core flange 222 fits within the cover flange 342. The locking protrusions 374 interface with the channels 320 such that the cover 216 is secured to the core 214. Together, the cover 216 and the core 214 form the housing 200 of the modular charger 102. The core rear face 220 functions as a rear face of the housing 200. The PCB 204, plate 202, coil section 206, and insulator 212 fit within the housing 200. More specifically, the PCB 204 fits within the cover flange 342 adjacent the core front face 218. The plate 202 fits within the core flange 222 between the PCB 204 and the cover rear face 340. The coil section 206 fits between the plate 202 and the cover rear face 340. The first wire end 322 and second wire end 324 extend through the PCB lumen 268 and plate port 282. The insulator 212 fits between the plate 202 and the coil section 206. The first wire end 322 and second wire end 324 are in electrical communication with the power cord 210.

The PCB 204 modulates current through the wire 310. This modulation is according to QI® protocols.

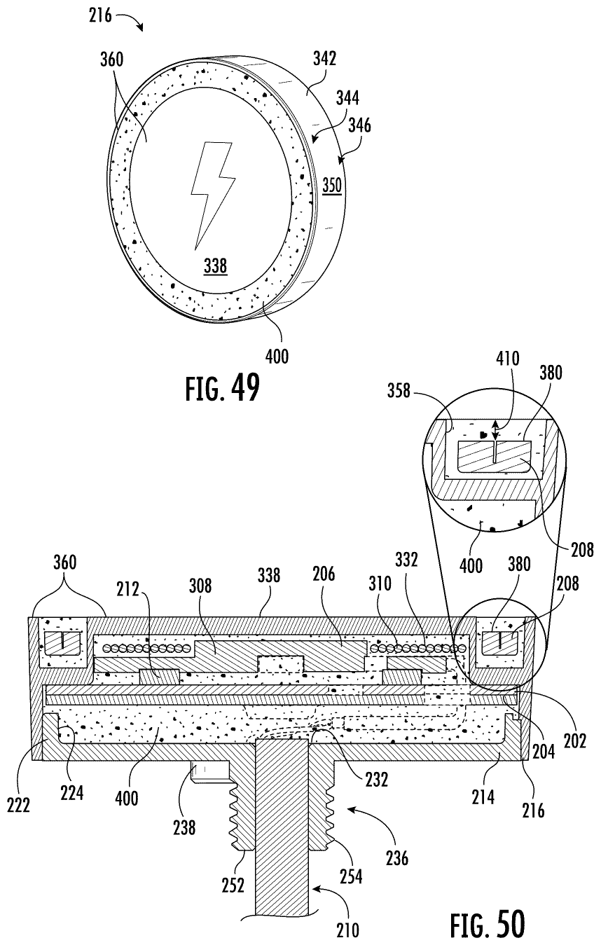

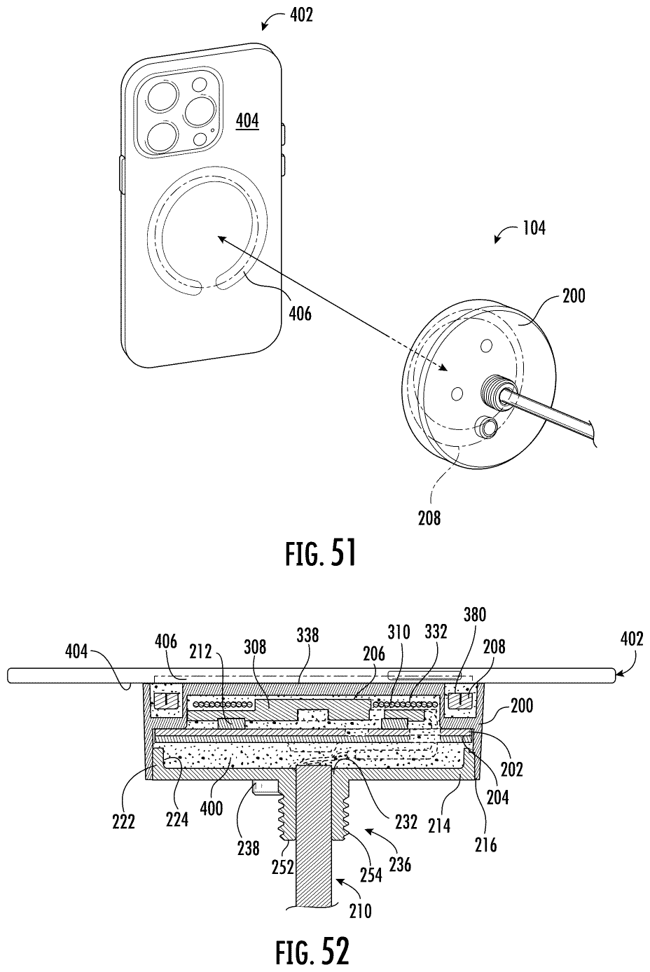

Referring to FIGS. 49-54, the magnetic ring 208 fits within the cover peripheral groove 358. In examples where the magnetic member 208 is not a magnetic ring 208, the cover peripheral groove 358 is shaped to match the shape of the magnetic member 208 such that the magnetic member 208 fits within the cover peripheral groove 358. An adhesive 400 is used to secure the magnetic ring 208 to the cover 216 within the cover peripheral groove 358. In the example shown, the adhesive 400 is a marine-grade, two-part epoxy 400. In other examples, the adhesive 400 may be one or more of: a different epoxy, such as a single-part epoxy, a resin, a glue, and the like. The adhesive 400 is water impermeable. The epoxy 400 also coats and encloses the magnetic ring 208 to protect the magnetic ring 208 from corrosion. The anchor protrusions 372 increase the security of attachment of the magnetic ring 208 via the epoxy 400 by increasing the surface area to which the epoxy 400 adheres within the cover peripheral groove 358 and by resisting rotation of the epoxy 400 within the cover peripheral groove 358 once the epoxy 400 cures and becomes solid.

The epoxy 400 over the ring front face 380 is coplanar with the planar portion 360 of the cover front face 338. The epoxy 400 is distributed in such a way within the cover peripheral groove 358 that the epoxy 400 and the planar portion 360 of the cover front face 338 form a substantially unitary and planar surface. The planar ring front face 380 can conform to and substantially contact (with the epoxy 400 in between) a device 402 with a planar surface 404. The device 402 has a magnetic array 406 that complements the magnetic ring 208 and allows the magnetic field of the magnetic ring 208 to exert a force on the device 402 to force the device 402 against the housing 200. The housing 200 couples the coil section 206 to the magnetic ring 208. The magnetic ring 208 engages the device 402 via the magnetic force of the magnetic ring 208 to position the device 402 relative to the wire 310 of the coil section 206. Because the magnetic ring 208 is secured to the outside of the housing 200, rather than secured inside a housing 200 as in prior art chargers, the planar ring front face 380 can be in substantially direct contact with the planar surface 404 of the device 402 at a planar boundary. As used herein, “substantially direct contact” in reference to two surfaces means the two surfaces are (1) in direct contact or (2) within tens of microns from direct contact. In the example shown, the ring front face 380 is not in direct contact with the surface 404 of the device 402 because the magnetic ring 208 is coated by the epoxy 400. The epoxy 400 has a thickness 410 of 1-16 microns over the ring front face 380. In other examples, the epoxy 400 may have a thickness 410 over the ring front face 380 of 1 micron, 2 microns, 3 microns, 1-3 microns, 5 microns, 1-5 microns, 7 microns, 1-7 microns, 5-10 microns, 5-15 microns, 10-15 microns, less than 16 microns, or another desired thickness 410.

Because magnetic fields decrease exponentially with distance from a source, coating the magnetic ring 208 with an epoxy 400 having a thickness 410 on the order of microns rather than positioning the magnetic ring 208 inside a housing 200 allows the magnetic ring 208 to exert a much higher magnetic force on the device 402 without increasing the strength of the magnetic field generally by positioning the device 402 where the magnetic field of the magnetic ring 208 is relatively strong. This is important because magnetic fields can inhibit performance of electronic devices like smartphones. Additionally, the magnetic field of the magnetic ring 208 can interfere with the induced magnetic field that is essential to an inductive charger's operation. Magnets designed for use in conjunction with smartphones are often limited in magnetic field strength. For example, Apple limits the magnetic flux density of MagSafe accessories to 0.215 T at the surface of the product. By allowing the ring front face 380 to be in substantially direct contact with a charged device 402, the magnetic force exerted by the magnetic ring 208 is maximized for the strength of the magnetic ring's 208 magnetic field. The magnetic flux density due to the magnetic ring 208 may be less than 0.215 T at the ring front face 380.

As stated, the magnetic ring 208 exerts a magnetic force on the charged device 402 that forces the charged device 402 against the housing 200. Because the magnetic ring 208 is in substantially direct contact with the charged device 402, the magnetic force is sufficiently strong to secure the charged device 402 against the housing 200, even when the modular charger 102 and the charged device 402 experience turbulence, as is often the case on watercraft or off-road vehicles. The magnetic force exerted on charged devices by typical chargers is not sufficiently strong to hold a charged device securely under such conditions. In the example shown, the magnetic ring 208 is the only means for forcing the device 402 against the housing 200. No other means are included for forcing the device 402 against the housing 200.

Referring back to FIGS. 2-8, the housing 200 is generally shaped like a conical frustum. As used in this context, “generally” means that distinctive characteristics of a conical frustum are exhibited in the housing 200, although, due to features such as the cover peripheral groove 358, the housing 200 is not strictly shaped like a conical frustum.

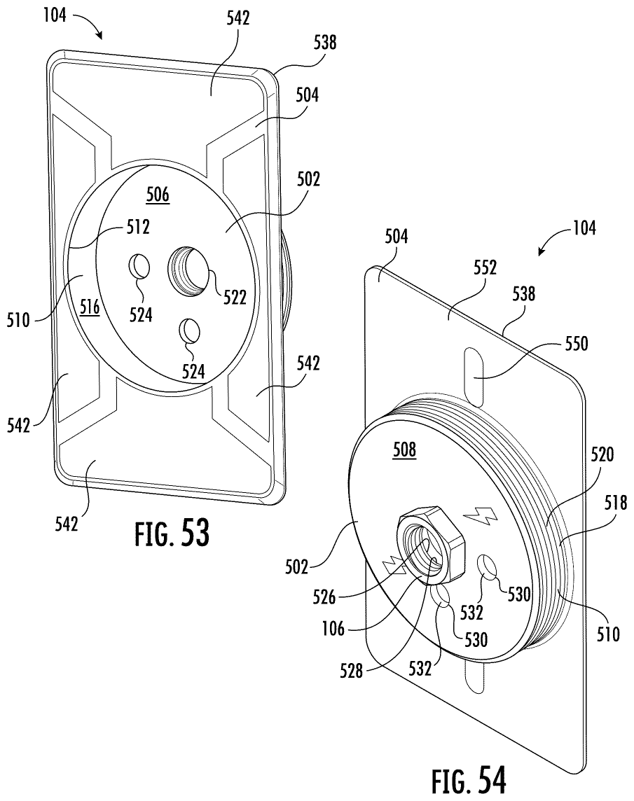

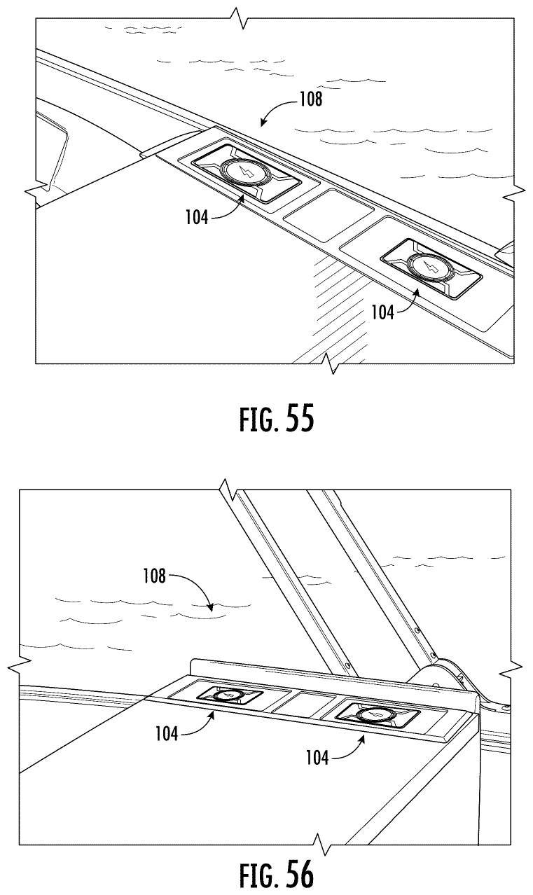

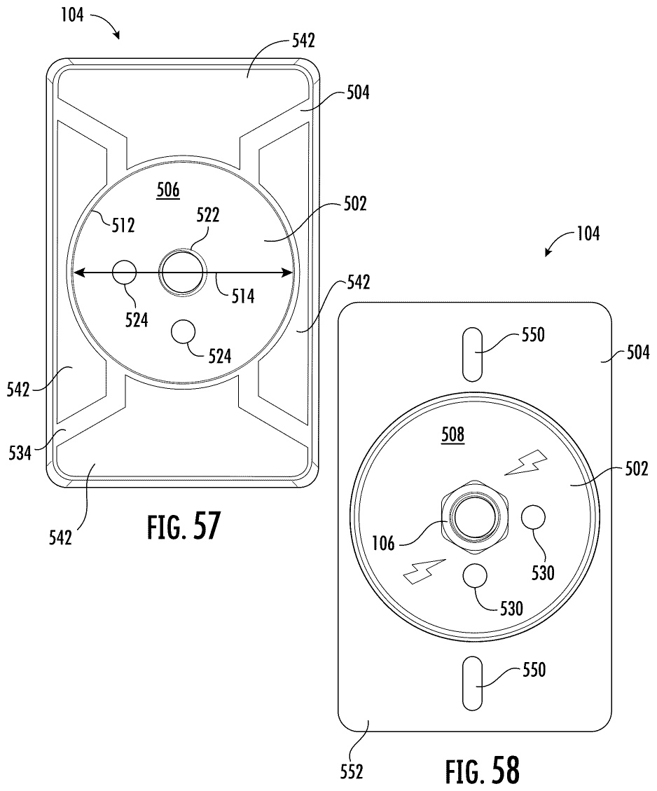

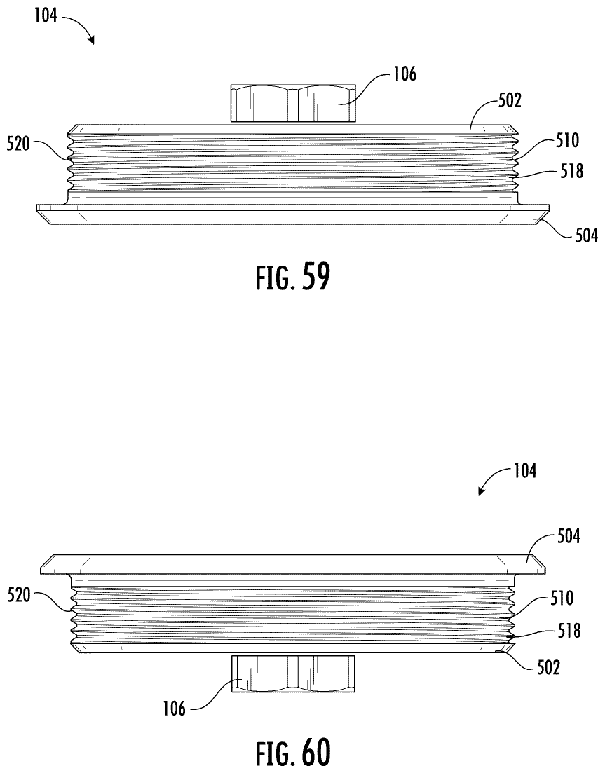

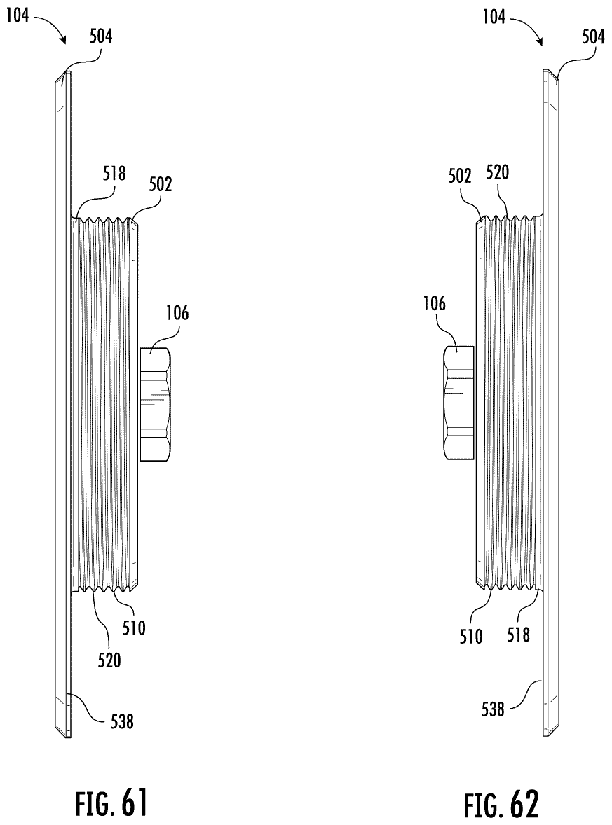

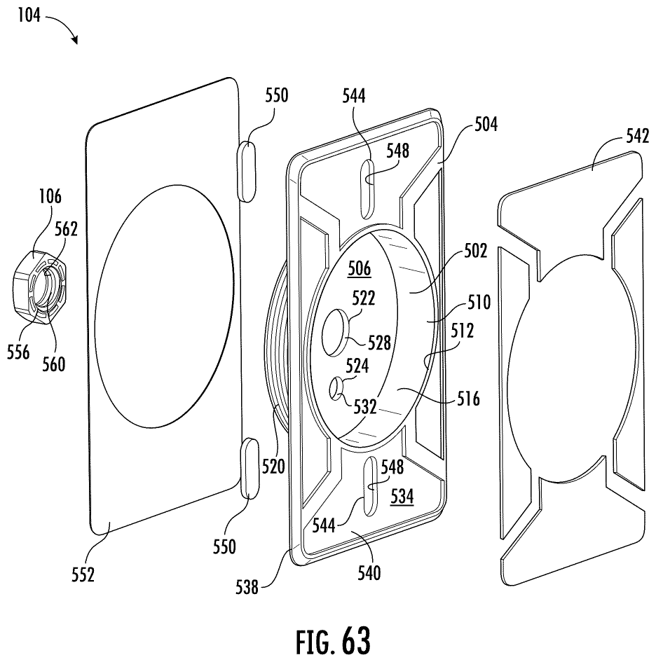

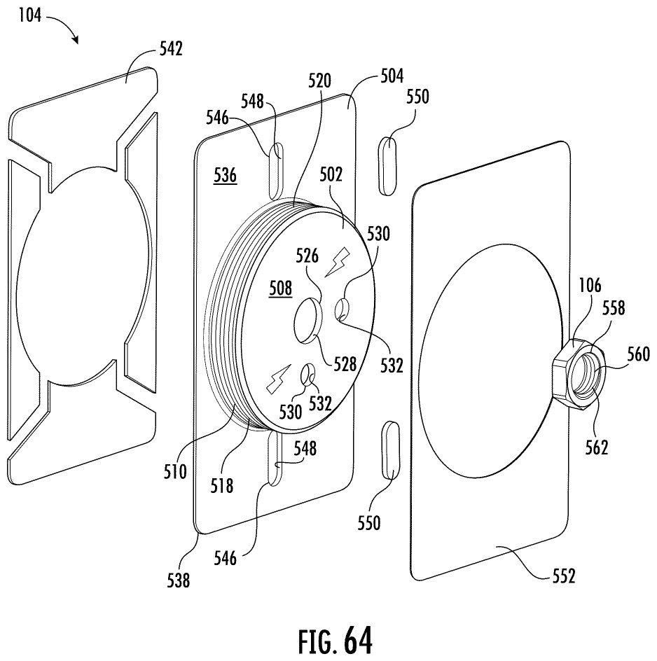

Referring to FIGS. 53-64, a first example of a receiver 104 is a form box 104 that includes a core receptacle 502, a module connector 106, and a support structure 504.

The core receptacle 502 includes a receptacle front face 506, a receptacle rear face 508, and a receptacle flange 510. The receptacle front face 506 and receptacle rear face 508 are separated by the height 240 of the offset collar. The receptacle flange 510 defines a receptacle flange aperture 512 with a receptacle flange inner diameter 514. The receptacle flange 510 has a receptacle flange interior surface 516 and a receptacle flange exterior surface 518. The receptacle flange interior surface 516 extends from the receptacle flange aperture 512 to the receptacle front face 506. The receptacle flange exterior surface 518 extends from the receptacle rear face 508 toward the receptacle flange aperture 512. The receptacle flange exterior surface 518 defines receptacle threads 520. The receptacle flange interior surface 516 is tapered such that the receptacle flange inner diameter 514 diminishes from the receptacle flange aperture 512 to the receptacle front face 506. The taper of the receptacle flange interior surface 516 complements the taper of the cover flange exterior surface 350.

The receptacle front face 506 defines a receptacle front central aperture 522 and receptacle front offset apertures 524. The receptacle rear face 508 defines a receptacle rear central aperture 526 and a receptacle central lumen 528 extending from the receptacle rear central aperture 526 to the receptacle front central aperture 522. The receptacle rear face 508 defines receptacle rear offset apertures 530 and receptacle offset lumens 532 extending from the respective receptacle rear offset apertures 530 to the respective receptacle front offset apertures 524. In the example shown, the core receptacle 502 includes two receptacle offset lumens 532, which are separated angularly by ninety degrees with respect to the receptacle central lumen 528. In the example shown, the core receptacle 502 is made from polymer, but in other examples, it may be made from one or more other materials, such as metals.

The support structure 504 extends radially from the receptacle flange 510. The support structure 504 has a support structure front face 534 and a support structure rear face 536 and terminates at a support structure edge 538. The support structure front face 534 extends from the receptacle flange aperture 512 to the support structure edge 538. The support structure front face 534 defines front recesses 540. Support structure inserts 542 fit within the front recesses 540. The support structure front face 534 defines clocking magnet front apertures 544. The support structure rear face 536 defines clocking magnet rear apertures 546 and clocking magnet channels 548 extending from the clocking magnet rear apertures 546 to the clocking magnet front apertures 544. The support structure 504 includes clocking magnets 550 that fit within the clocking magnet channels 548. The support structure 504 includes a support structure adhesive layer 552 that fits around the receptacle flange 510 and adjacent the support structure rear face 536. The support structure adhesive layer 552 allows the support structure 504 to be affixed to a surface, such as a boat hull. In the example shown, the support structure 504 is made from polymer and is unitary with the core receptacle 502. However, in other examples, the support structure 504 may be made from one or more other materials, such as metals, and/or may be separate from the core receptacle 502.

In the example shown, the module connector 106 is a locking nut 106 that includes a locking nut front aperture 556, a locking nut rear aperture 558, and a locking nut interior surface 560 extending from the locking nut front aperture 556 to the locking nut rear aperture 558. The locking nut interior surface 560 defines locking nut threads 562. In the example shown, the locking nut 106 is made from a polymer, but in other examples, the locking nut 106 may be made from one or more other materials, such as metals.

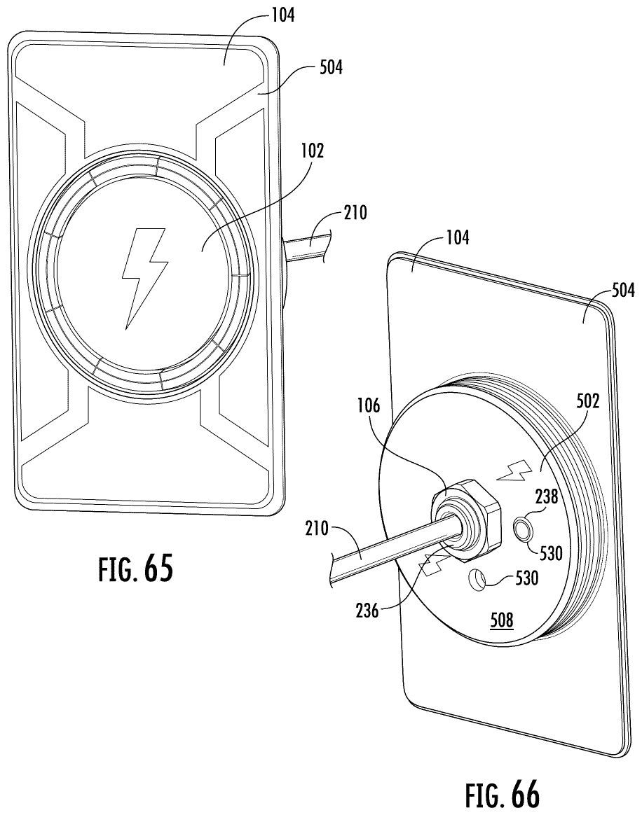

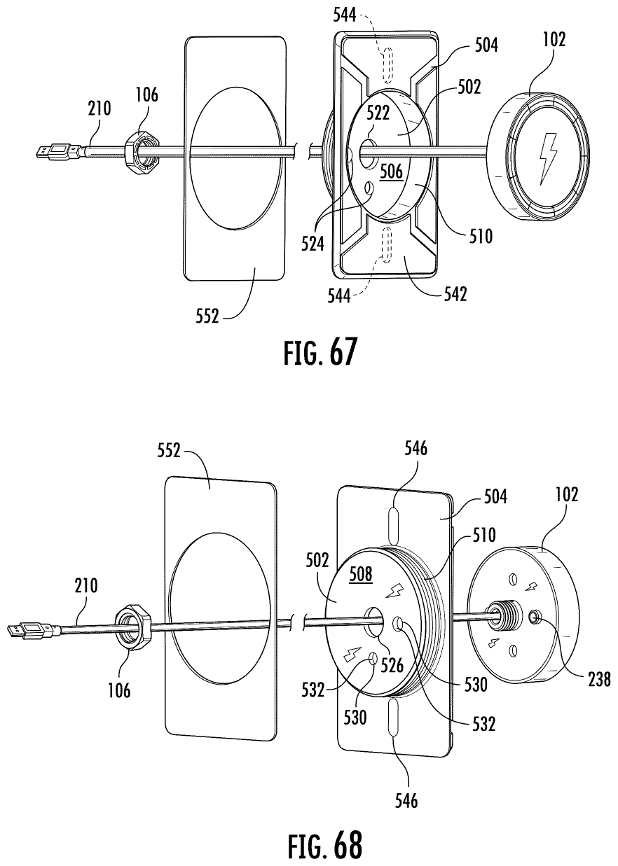

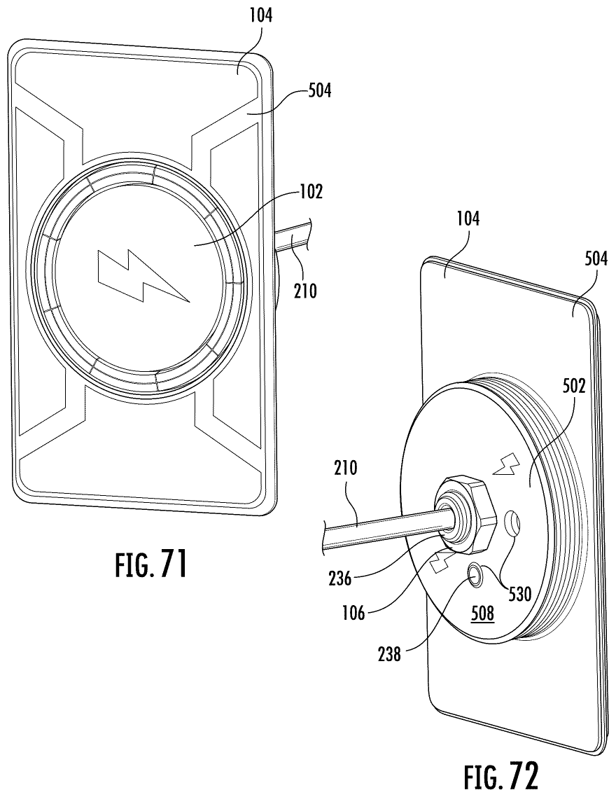

Referring to FIGS. 65-72, the example of a modular charger 102 is installed in the first example of a receiver 104. The module connector 106 releasably couples the receiver 104 to the modular charger 102. The locking nut threads 562 mate with the collar threads 254 so that the locking nut 106 can be screwed onto the central collar 236. In other examples, the module connector 106 may be a nut 106 fastened to the central collar 236 other than by threads. The module connector 106 may also include one or more of magnets, clips, clamps, cords, adhesives, friction fits, and the like. For example, the module connector 106 may be respective magnets in the housing 200 and the receiver 104 that releasably couple the housing 200 to the receiver 104. As another example, the module connector 106 may be an adhesive strip that releasably couples the modular charger 102 to the receiver 104, and the adhesive strip may need to be replaced after the modular charger 102 is decoupled from the receiver 104 and before it is recoupled to a receiver 104.

In the example shown, the receiver 104 is a form box 104. The housing 200 fits within the receptacle flange 510 such that the cover flange exterior surface 350 contacts the receptacle flange interior surface 516, and the central collar 236 extends through the receptacle central lumen 528. The offset collar 238 extends through one of the receptacle offset lumens 532. Placement of the offset collar 238 through an offset lumen 532 inhibits relative rotation of the modular charger 102 and the form box 104. The locking nut 106 is screwed onto the collar threads 254 such that the locking nut 106 is adjacent the receptacle rear face 508 and holds the modular charger 102 securely within the form box 104.

As stated above, the housing 200 is generally shaped like a conical frustum. This shape is important for at least two reasons. First, the taper of the cover flange exterior surface 350 facilitates a tight fit against the receptacle flange interior surface 516. Second, due to the circular shape of the cover flange 342, a receiver 104 can be designed to accept the modular charger 102 at any desired orientation relative to a normal axis of the cover front face 338. This can be accomplished by positioning a receptacle offset lumen 532 at an appropriate position relative to the receptacle central lumen 528. In other examples, the cover flange 342 may have different shapes while still maintaining this capability. For example, the cover flange 342 may be semi-circular, or it may be star-shaped or have another shape exhibiting sufficient radial symmetry.

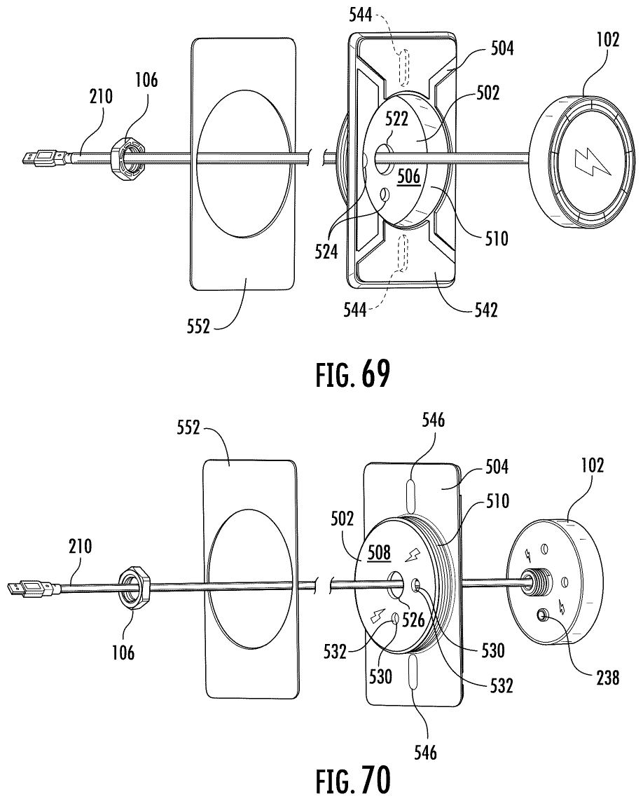

Referring to FIGS. 65-68, the modular charger 102 is in a first orientation. In this orientation, the offset collar 238 extends through a first of the receptacle offset lumens 532. Referring to FIGS. 69-72, the modular charger 102 is in a second orientation, rotated ninety degrees about a normal axis of the cover front face 338, relative to the first orientation. In the second orientation, the offset collar 238 extends through a second of the receptacle offset lumens 532.

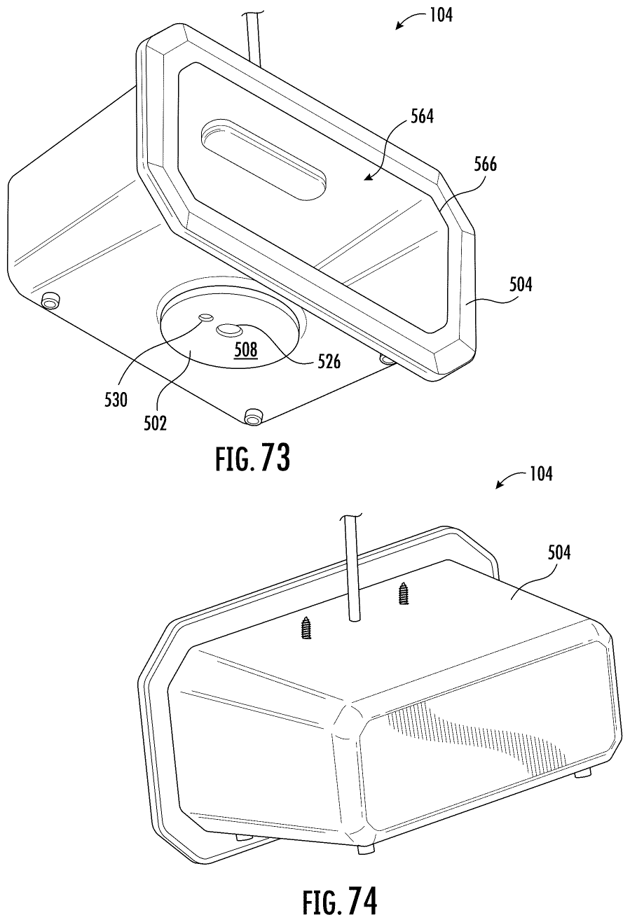

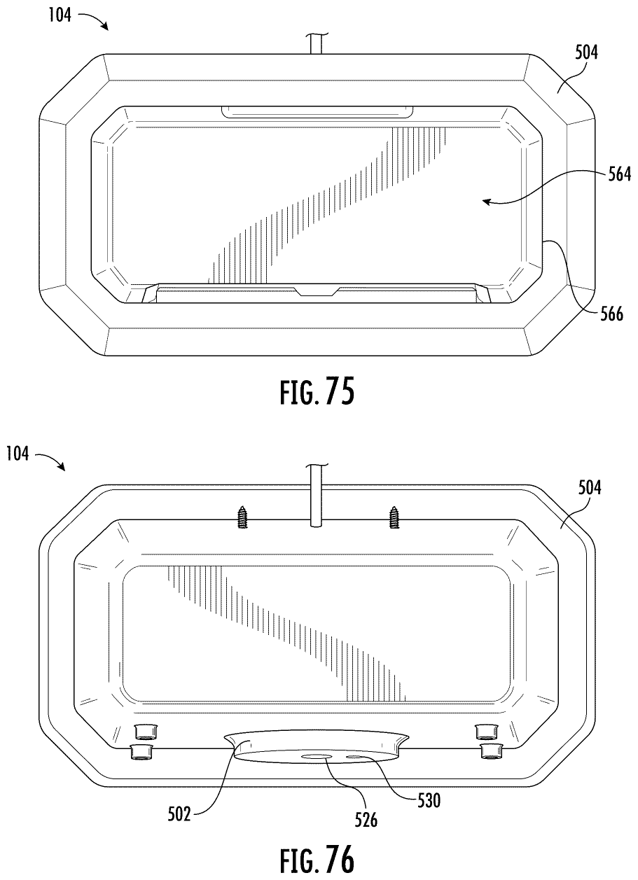

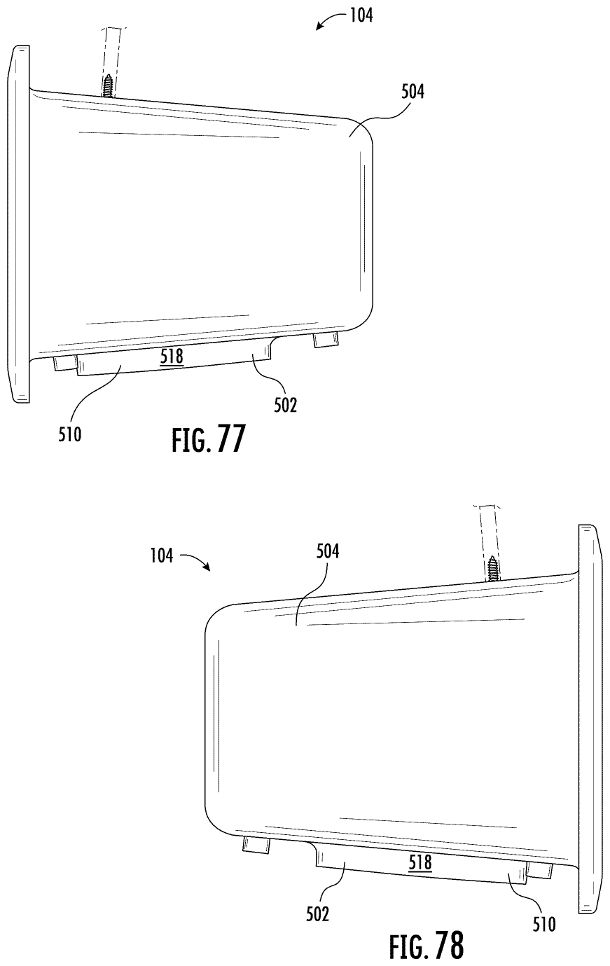

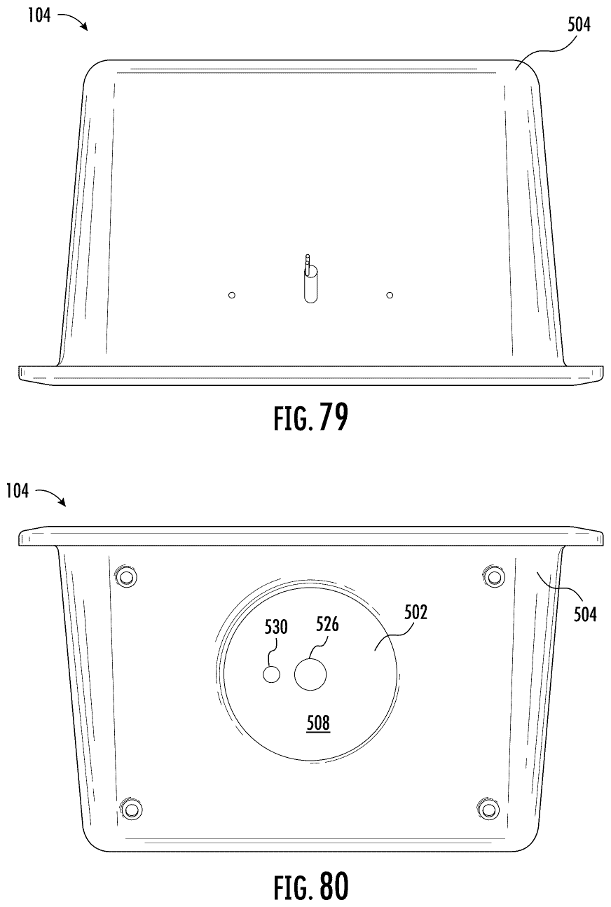

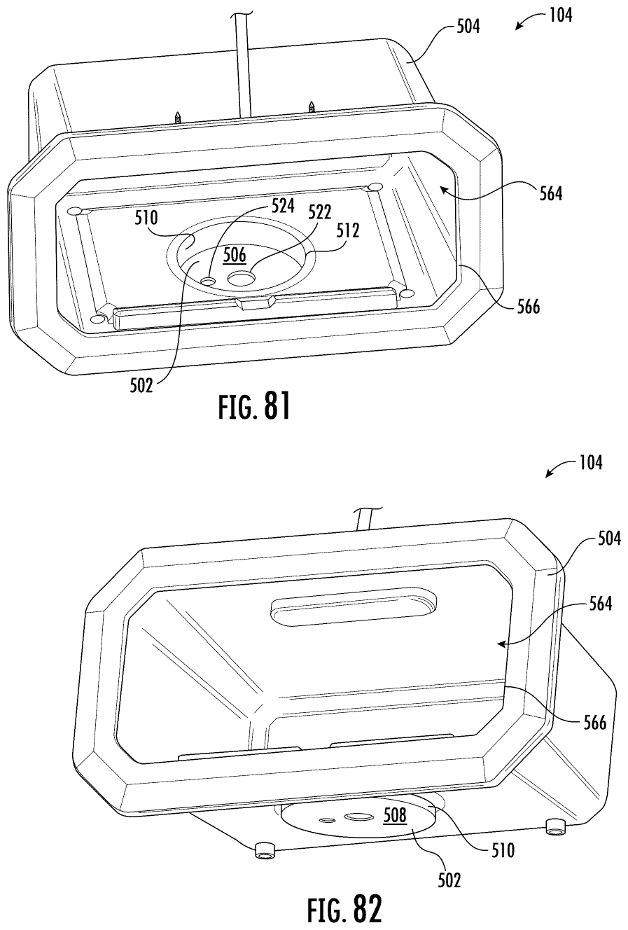

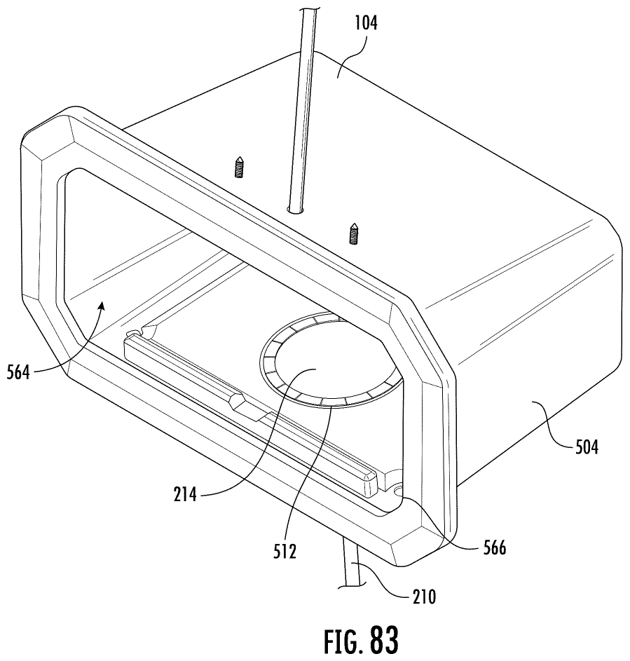

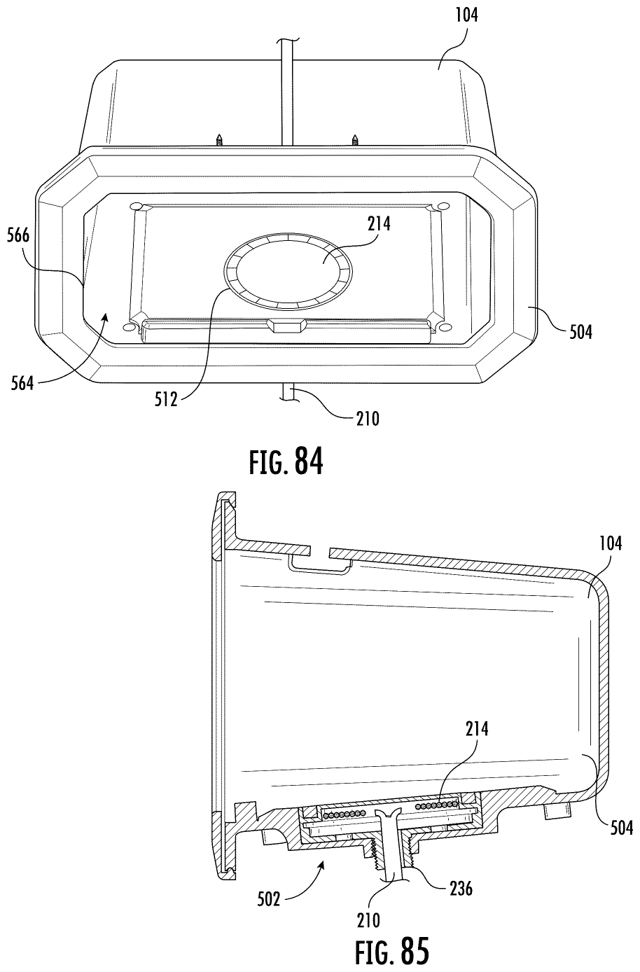

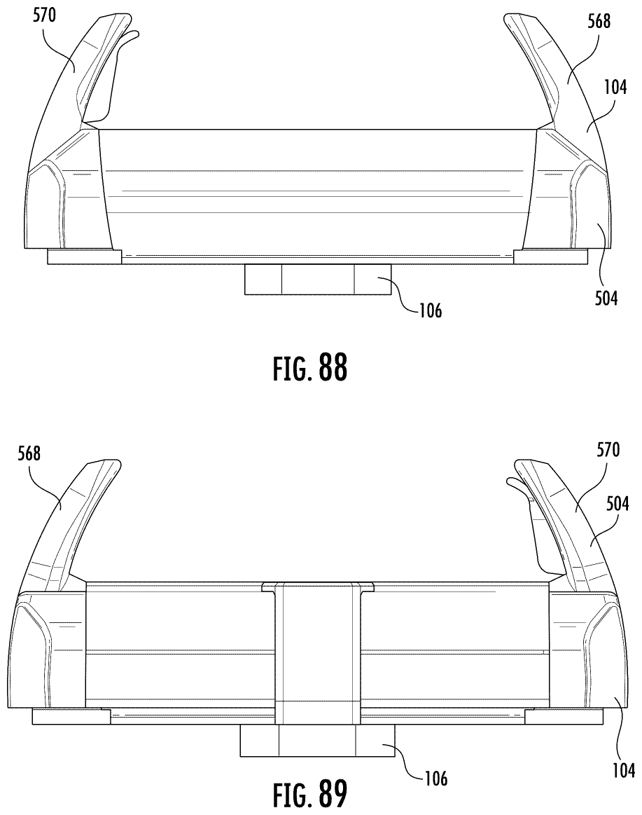

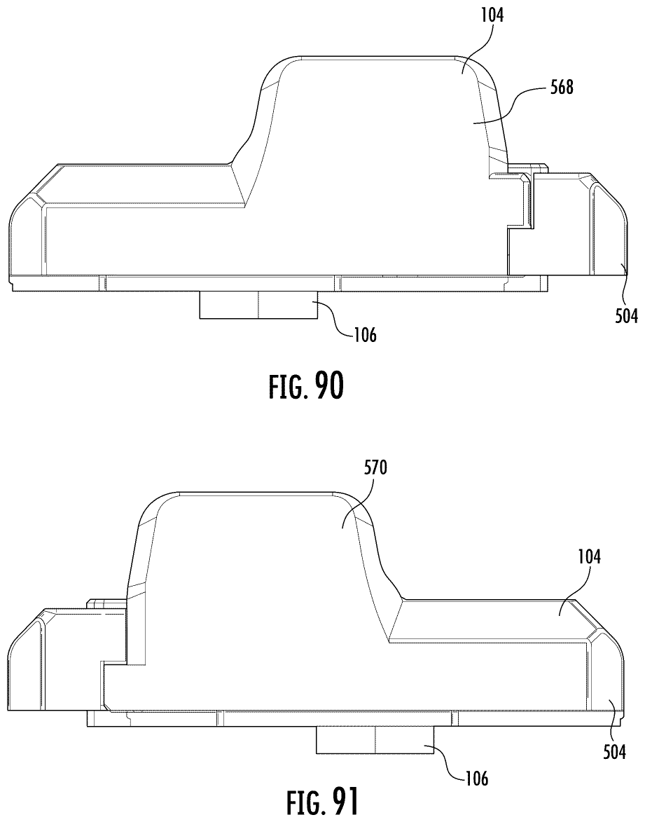

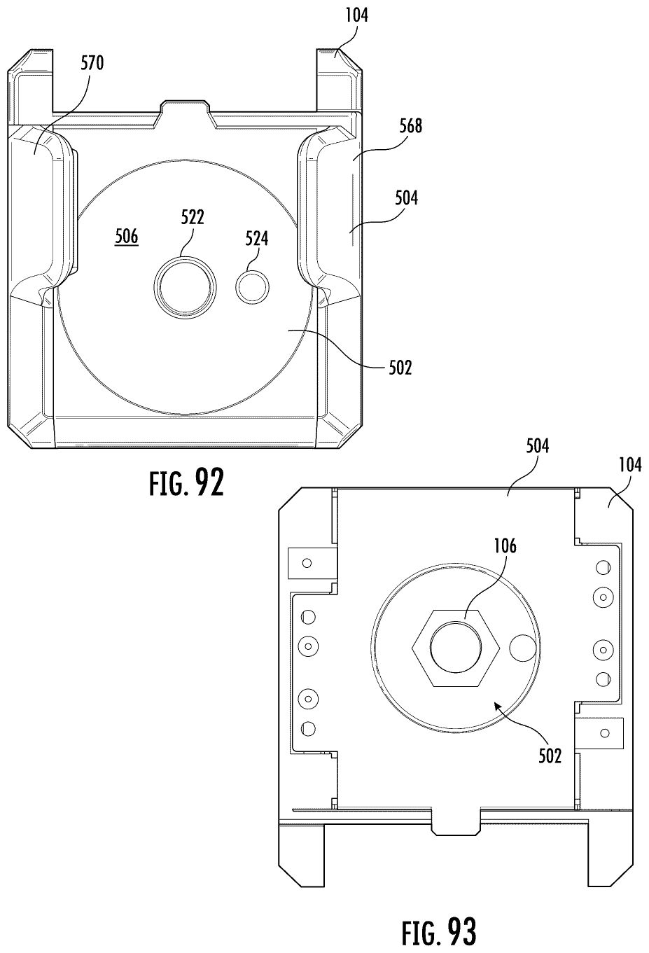

Referring to FIGS. 73-93, additional examples of form boxes 104 are shown. The additional examples are substantially similar to the first example, but certain differences from the first example are now described.

Referring to FIGS. 73-85, a second example of a form box 104 includes a support structure 504. The support structure 504 defines a cavity 564 with an opening 566.

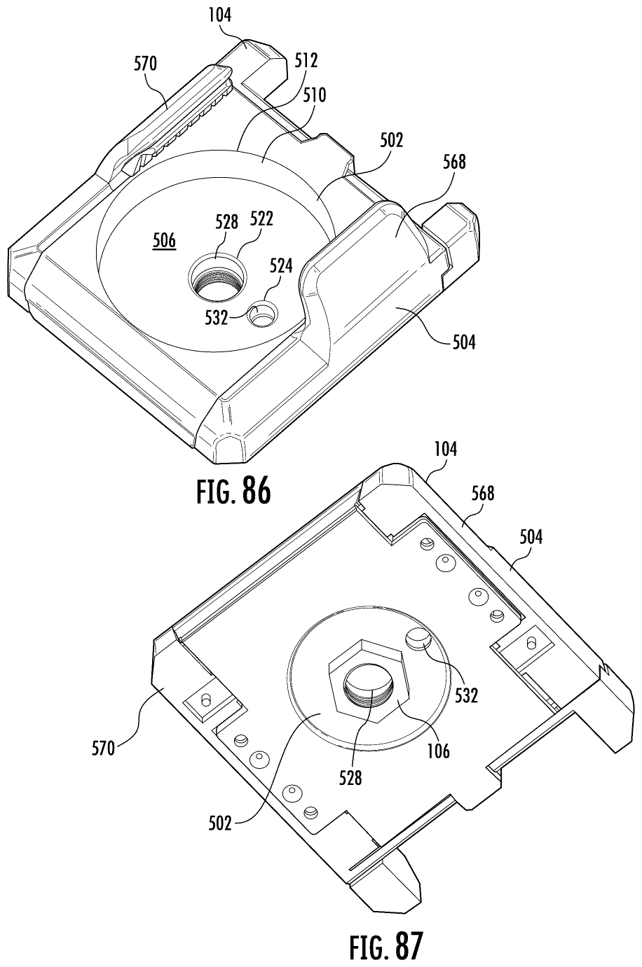

Referring to FIGS. 86-93, a third example of a form box 104 includes a support structure 504. The support structure 504 includes a first sidewall 568 and a second sidewall 570. The first sidewall 568 and second sidewall 570 are movable with respect to each other and clamp a charged device 402 to the form box 104.

The modular inductive charger and system are not limited to the details described in connection with the examples described here. There are numerous variations and modifications of the modular inductive charger and system that may be made without departing from the scope of what is claimed.

1. An inductive charger system comprising:
a modular charger having a waterproof housing, a coil within the housing, a magnetic member proximal the coil, and a PCB;
a receiver; and
a module connector for releasably coupling the receiver to the modular charger.

2. The inductive charger system of claim 1, wherein the housing is generally shaped like a conical frustum.

3. The inductive charger system of claim 1, wherein the module connector is a nut that screws onto the housing.

4. The inductive charger system of claim 1, wherein:
the housing is generally shaped like a conical frustum and has a rear face; and
further comprising:
a central collar protruding from a center of the rear face; and
an offset collar protruding from the rear face.

5. The inductive charger system of claim 4, wherein the module connector is a nut fastened to the central collar.

6. The inductive charger system of claim 1, wherein the PCB is within the housing.

7. The inductive charger system of claim 1, wherein the PCB is potted.

8. The inductive charger system of claim 1, wherein the coil is potted.

9. The inductive charger system of claim 1, wherein the receiver is part of a watercraft.

10. An apparatus for inductively charging a device, the device having a planar surface, the apparatus comprising:
a wire coil;
a magnetic member with a planar face; and
a housing surrounding the wire coil and coupling the wire coil to the magnetic member;
wherein the face of the magnetic member can be in substantially direct contact with the surface of the device at a planar boundary.

11. The apparatus of claim 10, further comprising epoxy enclosing the magnetic member.

12. The apparatus of claim 10, further comprising epoxy having a thickness of 1-16 microns over the face of the magnetic member.

13. The apparatus of claim 10, wherein:
the housing defines a recess; and
the magnetic member is within the recess.

14. The apparatus of claim 13, further comprising epoxy within the recess to secure the magnetic member within the recess.

15. The apparatus of claim 13, wherein the recess includes anchor protrusions.

16. The apparatus of claim 10, wherein:
a magnetic force of the magnetic member can force a charged device against the housing; and
the apparatus does not include any other means for forcing the device against the housing.

17. The apparatus of claim 10, wherein the magnetic member engages a charged device via magnetic force of the magnetic member to position the device relative to the wire coil.

18. The apparatus of claim 10, wherein:
the magnetic member is annular; and
a magnetic flux density due to the magnetic member does not exceed 0.215 T at the face of the magnetic member.

19. The apparatus of claim 10, wherein:
the magnetic member is annular; and
an inner diameter of the magnetic member is 46 millimeters.

20. An inductive charger system (100) comprising:
a core (214) having a front face (218) and a rear face (220), a flange (222) extending from the front face (218) and defining channels (230), a central collar (236) protruding from the rear face (220) and defining a central lumen (244), and an offset collar (238) protruding from the rear face (220) and defining an offset lumen (248);
a coil section (206) having an insulative polymer frame (308) and a coil of copper wire (310);
a potted PCB (204) for modulating current through the wire (310);
an aluminum alloy plate (202) defining plate holes (288) therethrough;
a polymer insulator (212);
a cover (216) having a front surface (338) defining a planar portion (360) and a peripheral groove (358) with anchor protrusions (372), a rear surface (340), and a tapered flange (342) extending away from the rear surface (340) and defining locking protrusions (374);
a magnetic ring (208) within the peripheral groove (358); and
epoxy (400) within the peripheral groove (358) and fully encasing the magnetic ring (208) to secure the magnetic ring (208) within the peripheral groove (358);
the epoxy (400) being distributed such that the epoxy (400) and the planar portion (360) form a substantially unitary and planar surface;
the locking protrusions (374) of the cover being within the channels (230) of the core (214) to secure the cover (216) to the core (214);
the coil section (206), PCB (204), plate (202), and insulator (212) being between and enclosed by the cover (216) and the core (214).
